(19) United States
(12) Patent Application Publication
(10) Pub. No.: US 2025/0332833 A1
(43) Pub. Date: Oct. 30, 2025

(54) LIQUID EJECTING HEAD AND LIQUID EJECTING APPARATUS

(71) Applicant: SEIKO EPSON CORPORATION, Tokyo (JP)

(72) Inventor: Shingo TOMIMATSU, SHIOJIRI-SHI (JP)

(21) Appl. No.: 19/187,605

(22) Filed: Apr. 23, 2025

(30) Foreign Application Priority Data
Apr. 26, 2024 (JP) 2024-072331

(51) Int. Cl. B41J 2/14; B41J 2/16

(52) U.S. Cl. CPC B41J 2/14233; B41J 2/1618; B41J 2002/14266

(57) ABSTRACT

A liquid ejecting head includes a first member that defines a portion of a common liquid chamber communicating with nozzles, a second member that has a linear expansion coefficient larger than that of the first member, and a flexible member that is fixed to the first member and the second member, in which the flexible member includes a flexible region that is not fixed to both the first member and the second member, and an outer peripheral region between the flexible region and a region that is fixed to both the first member and the second member, and the outer peripheral region has a first region that is fixed to the first member but not fixed to the second member, the first region occupying 60% or more of the entire periphery of the outer peripheral region.

The present application is based on, and claims priority from JP Application Serial Number 2024-072331, filed Apr. 26, 2024, the disclosure of which is hereby incorporated by reference herein in its entirety.

### BACKGROUND

### 1. Technical Field

The present disclosure relates to a liquid ejecting head and a liquid ejecting

apparatus that eject a liquid from nozzles, and particularly, to an ink jet recording head and an ink jet recording apparatus that eject ink as a liquid.

### 2. Related Art

A liquid ejecting apparatus represented by an ink jet recording apparatus, such as an ink jet printer or plotter, includes a liquid ejecting head that is capable of ejecting a liquid, such as ink stored in a cartridge, a tank or the like, as liquid droplets.

The liquid ejecting head is disclosed to have a configuration including a flow path forming plate corresponding to a first member made of silicon that defines a common liquid chamber communicating with a plurality of nozzles, and a compliance substrate including an elastic film corresponding to a flexible member and a support body corresponding to a second member made of stainless steel. It is also disclosed that the compliance substrate is fixed to the flow path forming plate on the surface opposite to the surface on which the support body of the elastic film is provided, and each element of the liquid ejecting head is fixed with an adhesive such as a thermosetting adhesive (see, for example, JP-A-2017-30222).

However, since the linear expansion coefficient of the second member that pinches the flexible member is different from the linear expansion coefficient of the first member, there was a concern that wrinkles would occur in the flexible member when the thermosetting adhesive used to bond each element contained in the liquid ejecting head was cured at a high temperature and then returned to room temperature.

### SUMMARY

According to an aspect of the present disclosure, there is provided a liquid ejecting head including: a first member that defines a portion of a common liquid chamber communicating with a plurality of nozzles that eject a liquid; a second member; and a flexible member having a first surface fixed to a first fixing surface of the first member and a second surface opposite to the first surface and fixed to the second member, in which the first fixing surface has a flow path opening through which the common liquid chamber opens, the flexible member includes a flexible region that overlaps the flow path opening when viewed in a stacking direction of the first member and the flexible member and is not fixed to the second member, and an outer peripheral region that surrounds the flexible region when viewed in the stacking direction and is between the flexible region and a region that is fixed to both the first member and the second member, the outer peripheral region includes at least a first region that is fixed to the first member but not fixed to the second member, a linear expansion coefficient of the first member is smaller than a linear expansion coefficient of the second member, and 60% or more of an entire periphery of the outer peripheral region is the first region.

According to another aspect of the present disclosure, there is provided a liquid ejecting head including: a first member that defines a portion of a common liquid chamber communicating with a plurality of nozzles that eject a liquid; a second member; and a flexible member having a first surface fixed to a first fixing surface of the first member and a second surface opposite to the first surface and fixed to the second member, in which the first fixing surface has a flow path opening through which the common liquid chamber opens, the flexible member includes a flexible region that overlaps the flow path opening when viewed in a stacking direction of the first member and the flexible member and is not fixed to the second member, and an outer peripheral region that surrounds the flexible region when viewed in the stacking direction and is between the flexible region and a region that is fixed to both the first member and the second member, the outer peripheral region includes at least a second region that is fixed to the second member but not fixed to the first member, a linear expansion coefficient of the second member is smaller than a linear expansion coefficient of the first member, and 60% or more of an entire periphery of the outer peripheral region is the second region.

According to still another aspect of the present disclosure, there is provided a liquid ejecting apparatus including: the liquid ejecting head according to the above aspect; and a liquid storage portion that stores a liquid to be supplied to the liquid ejecting head.

### BRIEF DESCRIPTION OF THE DRAWINGS

FIG. 1 is a diagram showing a schematic configuration of a liquid ejecting apparatus according to a first embodiment.

FIG. 2 is an exploded perspective view of a liquid ejecting head according to the first embodiment.

FIG. 3 is a plan view of a main portion of the liquid ejecting head according to the first embodiment.

FIG. 4 is a cross-sectional view of the liquid ejecting head according to the first embodiment.

FIG. 5 is an enlarged cross-sectional view of a main portion of the liquid ejecting head according to the first embodiment.

FIG. 6 is a cross-sectional view of a main portion for describing a bonding process of a configuration according to the related art.

FIG. 7 is a cross-sectional view of a main portion for describing a bonding process according to the first embodiment.

FIG. 8 is a cross-sectional view of a main portion for describing a modification example of the bonding process according to the first embodiment.

FIG. 9 is a table showing combination examples of materials according to the first embodiment.

FIG. 10 is a table showing combination examples of materials according to the first embodiment.

FIG. 11 is a plan view of a main portion of a liquid ejecting head according to a second embodiment.

FIG. 12 is a cross-sectional view of the liquid ejecting head according to the second embodiment.

FIG. 13 is a plan view of a main portion of a liquid ejecting head according to a third embodiment.

FIG. 14 is a cross-sectional view of a main portion of the liquid ejecting head according to the third embodiment.

FIG. 15 is a cross-sectional view of a main portion showing a modification example of the liquid ejecting head according to the third embodiment.

FIG. 16 is a plan view of a main portion of a liquid ejecting head according to a fourth embodiment.

FIG. 17 is a cross-sectional view of a main portion of the liquid ejecting head according to the fourth embodiment.

FIG. 18 is a plan view of a main portion of a liquid ejecting head according to a fifth embodiment.

FIG. 19 is a cross-sectional view of a main portion of the liquid ejecting head according to the fifth embodiment.

FIG. 20 is a cross-sectional view of a main portion for describing a bonding process according to the fifth embodiment.

FIG. 21 is a table showing combination examples of materials according to the fifth embodiment.

FIG. 22 is a table showing combination examples of materials according to the fifth embodiment.

### DESCRIPTION OF EMBODIMENTS

The present disclosure will be described in detail below based on embodiments. However, the following description shows one embodiment of the present disclosure, and can be modified as desired within the scope of the present disclosure. In each drawing, the same reference numerals indicate the same members, and the description thereof will be omitted as appropriate. In each drawing, X, Y, and Z represent three spatial axes that are orthogonal to each other. In the present specification, the directions along these axes are referred to as an X direction, a Y direction, and a Z direction. In each drawing, a direction indicated by the arrow is a positive (+) direction, and a direction opposite to the arrow is a negative (−) direction. The Z direction indicates a vertical direction, the +Z direction indicates a vertically downward direction, and the −Z direction indicates a vertically upward direction. Furthermore, the directions of three spatial axes that do not limit the positive direction and the negative direction will be described as the X-axis direction, the Y-axis direction, and the Z-axis direction.

### First Embodiment

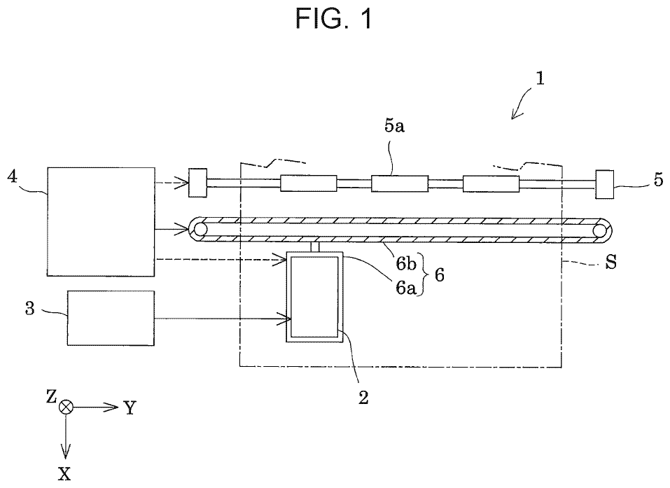

FIG. 1 is a diagram showing a schematic configuration of a liquid ejecting apparatus 1 according to the present disclosure.

As shown in the drawing, the liquid ejecting apparatus 1 is an ink jet recording apparatus that causes ink, which is one type of liquid, to be ejected and land on a medium S such as a printing paper sheet as ink droplets, and prints an image or the like based on an arrangement of dots formed at the medium S. As the medium S, in addition to recording paper, any material such as a resin film or cloth can be used.

The liquid ejecting apparatus 1 includes a liquid ejecting head 2, a liquid storage portion 3, a control unit 4 which is a control portion, a transport mechanism 5 that feeds out a medium S, and a moving mechanism 6.

The liquid ejecting head 2 ejects ink supplied from the liquid storage portion 3 from a plurality of nozzles in the +Z direction.

The liquid storage portion 3 stores the ink ejected from the liquid ejecting head 2. Examples of the liquid storage portion 3 include a cartridge that is attachable and detachable to the liquid ejecting apparatus 1, a bag-shaped ink pack made of a flexible film, and an ink tank that can be replenished with ink. Note that, although not particularly shown, for example, a plurality of types of ink having different colors or components are individually stored in the liquid storage portion 3. Furthermore, the liquid storage portion 3 may be divided into a main tank and a sub-tank. The sub-tank may be coupled to the liquid ejecting head 2, and ink consumed by ejecting ink droplets from the liquid ejecting head 2 may be replenished from the main tank.

The control unit 4 includes, for example, a control device such as a central processing unit (CPU) or a field programmable gate array (FPGA), and a storage device such as a semiconductor memory. The control unit 4 totally controls each element of the liquid ejecting apparatus 1, that is, the liquid ejecting head 2, the transport mechanism 5, the moving mechanism 6, and the like by executing the program stored in the storage device by the control device.

The transport mechanism 5 transports the medium S in the X-axis direction, and has a transport roller 5a. That is, the transport mechanism 5 transports the medium S in the X-axis direction by rotating the transport roller 5a. The transport mechanism 5 that transports the medium S is not limited to the one including the transport roller 5a, and may transport the medium S by a belt or a drum, for example.

The moving mechanism 6 includes a transport body 6a and a transport belt 6b. The transport body 6a is a substantially box-shaped structure for accommodating the liquid ejecting head 2, a so-called carriage, and is fixed to the transport belt 6b. The transport belt 6b is an endless belt erected along the Y-axis direction. The transport belt 6b is rotated by the drive of a transport motor (not shown). The control unit 4 rotates the transport belt 6b by controlling the drive of the transport motor to reciprocate the liquid ejecting head 2 together with the transport body 6a in the Y-axis direction along a guide rail (not shown). The liquid storage portion 3 can also be mounted on the transport body 6a together with the liquid ejecting head 2.

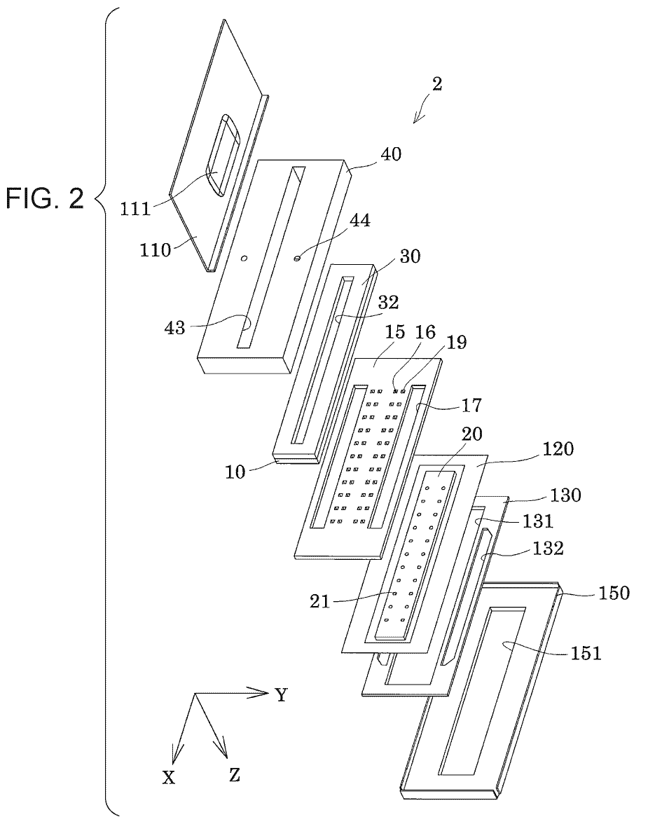

Under the control of the control unit 4, the liquid ejecting head 2 executes an ejection operation of ejecting the ink supplied from the liquid storage portion 3 in the +Z direction as ink droplets from each of a plurality of nozzles 21 (refer to FIG. 2). The ejection operation of ink droplets by the liquid ejecting head 2 is performed in parallel with the transport of the medium S by the transport mechanism 5 and the reciprocating movement of the liquid ejecting head 2 by the moving mechanism 6, and accordingly, an image is formed by ink on the surface of the medium S, that is, a so-called printing operation is performed.

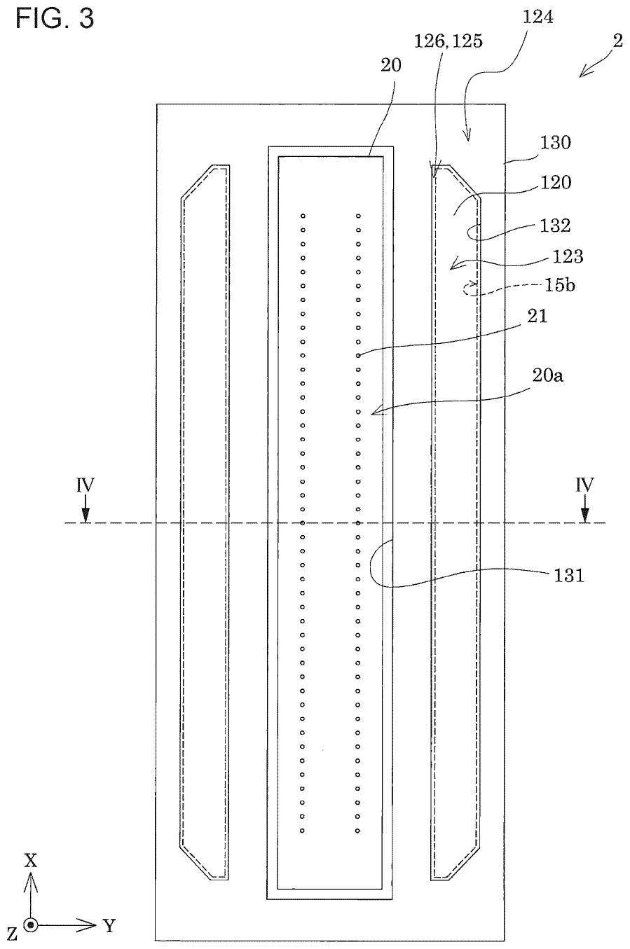

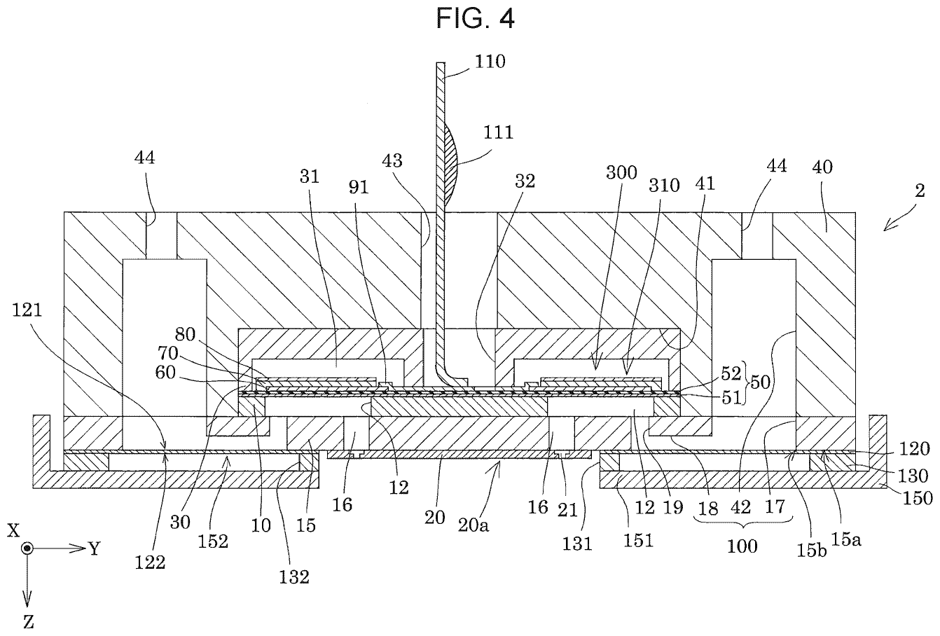

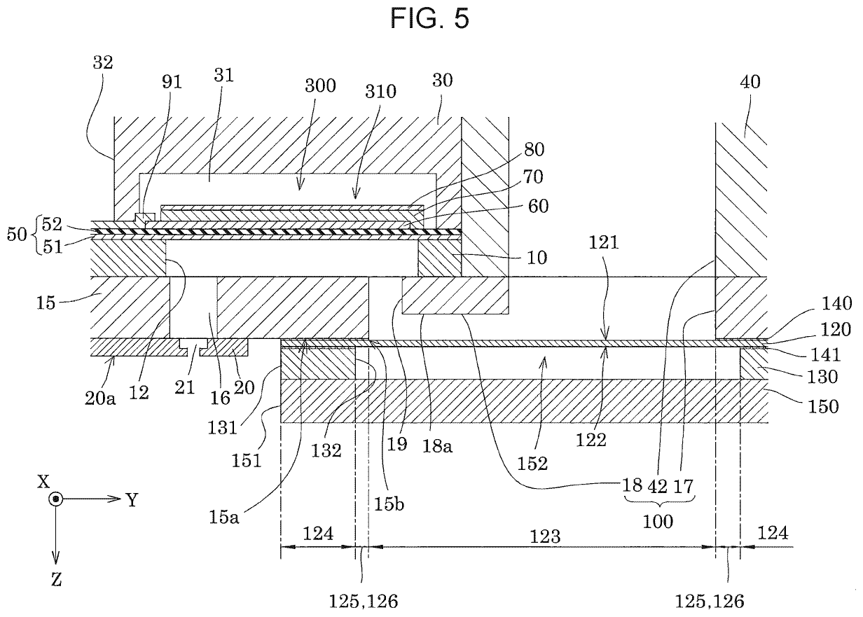

The liquid ejecting head 2 will be described with reference to FIGS. 2 to 5. FIG. 2 is an exploded perspective view of the liquid ejecting head 2. FIG. 3 is a plan view of the liquid ejecting head 2 when viewed in the −Z direction with a cover head 150 removed from the liquid ejecting head 2. FIG. 4 is a cross-sectional view of the liquid ejecting head 2 taken along line IV-IV of FIG. 3. FIG. 5 is an enlarged cross-sectional view of the main portion of FIG. 4. Each direction of the liquid ejecting head 2 will be described based on the directions when mounted on the liquid ejecting apparatus 1, that is, the X-axis direction, the Y-axis direction, and the Z-axis direction. Naturally, the position of the liquid ejecting head 2 in the liquid ejecting apparatus 1 is not limited to those shown below.

As shown in the drawing, the liquid ejecting head 2 includes a flow path forming substrate 10, a communication plate 15, a nozzle plate 20 on which the plurality of nozzles 21 are formed, a protective substrate 30, a case member 40, a flexible member 120, a frame body 130, the cover head 150, and a piezoelectric actuator 300.

The flow path forming substrate 10 is made of, for example, a silicon substrate. On the flow path forming substrate 10, a plurality of pressure chambers 12 are disposed side by side along the X-axis direction. The plurality of pressure chambers 12 are disposed on a straight line along the X-axis direction such that positions in the Y-axis direction are the same. In the present embodiment, two pressure chamber rows, in which the pressure chambers 12 are arranged side by side along the X-axis direction, are provided in the Y-axis direction. The pressure chambers 12 constituting these two pressure chamber rows are disposed at the same position in the X-axis direction. The two pressure chamber rows may be disposed to be shifted from each other in the X-axis direction by half the pitch of the pressure chambers 12, that is, by a so-called half pitch. In other words, all the pressure chambers 12 in the two pressure chamber rows may be disposed in a staggered manner along the X-axis direction.

The communication plate 15 and the nozzle plate 20 are sequentially stacked on the surface of the flow path forming substrate 10 facing the +Z direction. A vibration plate 50 and the piezoelectric actuator 300 are sequentially stacked on the surface of the flow path forming substrate 10 facing the −Z direction.

The communication plate 15 is formed of a plate-shaped member bonded to the surface of the flow path forming substrate 10 facing the +Z direction. The communication plate 15 is provided with a nozzle communication passage 16 that makes the pressure chamber 12 and the nozzle 21 communicate with each other. The communication plate 15 is provided with a first manifold portion 17 and a second manifold portion 18 that constitute a portion of a manifold 100 through which the plurality of pressure chambers 12 communicate in common. The first manifold portion 17 is provided to penetrate the communication plate 15 in the Z-axis direction. Further, the second manifold portion 18 is provided to be open on the surface facing the +Z direction without penetrating the communication plate 15 in the Z-axis direction. Furthermore, the communication plate 15 is provided with a supply communication passage 19 that communicates with the pressure chamber 12 independently for each pressure chamber 12. Each of a plurality of supply communication passages 19 causes the second manifold portion 18 and each of the plurality of pressure chambers 12 to communicate with each other, and supplies the ink in the manifold 100 to each of the pressure chambers 12. In other words, the supply communication passage 19 is disposed at a position overlapping the second manifold portion 18 when viewed in the Z-axis direction.

The nozzle plate 20 is bonded to the side of the communication plate 15 opposite to the flow path forming substrate 10, that is, to the surface facing the +Z direction. The nozzle plate 20 has a plurality of nozzles 21 formed therein, which communicate with each of the pressure chambers 12 through the nozzle communication passage 16. In the present embodiment, the plurality of nozzles 21 are arranged side by side in a row along the X-axis direction for each pressure chamber row. That is, in the present embodiment, two nozzle rows, in which the nozzles 21 are arranged side by side along the X-axis direction, are provided spaced apart in the Y-axis direction. The nozzles 21 constituting the two nozzle rows are disposed to be at the same position in the X-axis direction. Of course, when the two pressure chamber rows are disposed at positions shifted from each other by half the pitch of the pressure chambers 12 in the X-axis direction, the two nozzle rows may also be similarly disposed at positions shifted from each other by half the pitch of the nozzles 21 in the X-axis direction. In other words, all of the nozzles 21 in the two nozzle rows may be disposed in a staggered manner along the X-axis direction.

Such a nozzle plate 20 is made of, for example, a silicon substrate. The surface of the nozzle plate 20 facing the +Z direction is referred to as a nozzle surface 20a.

In the present embodiment, the individual flow paths communicating with the nozzles 21 include a supply communication passage 19, a pressure chamber 12, and a nozzle communication passage 16, and the communication plate 15 defines the supply communication passage 19, which is a portion of the individual flow paths communicating with the second manifold portion 18, which is a portion of the manifold 100.

In the present embodiment, the vibration plate 50 has, for example, an elastic film 51 made of silicon oxide provided on the surface of the flow path forming substrate 10 facing the −Z direction, and an insulator film 52 made of zirconium oxide provided on the surface of the elastic film 51 facing the −Z direction. The vibration plate 50 may be composed of only the elastic film 51, or may be composed of only the insulator film 52, or may have another film in addition to the elastic film 51 and the insulator film 52.

The piezoelectric actuator 300 includes a first electrode 60, a piezoelectric layer 70, and a second electrode 80 that are sequentially stacked on the vibration plate 50 in the −Z direction. Such a piezoelectric actuator 300 is also called a piezoelectric element, and refers to a portion including the first electrode 60, the piezoelectric layer 70, and the second electrode 80. In addition, a portion where piezoelectric strain occurs in the piezoelectric layer 70 when a voltage is applied between the first electrode 60 and the second electrode 80 is referred to as an active portion 310. That is, the active portion 310 refers to a portion where the piezoelectric layer 70 is interposed between the first electrode 60 and the second electrode 80. In the present embodiment, the active portion 310 is formed for each pressure chamber 12. The plurality of active portions 310 serve as “drive elements” that cause pressure changes in the ink inside the pressure chamber 12. In general, one of the electrodes of the active portion 310 is configured as an independent individual electrode for each active portion 310, and the other electrode is configured as a common electrode common to the plurality of active portions 310. In the present embodiment, the first electrode 60 is separated for each active portion 310 to form an individual electrode of the active portion 310, and the second electrode 80 is continuously provided over the plurality of active portions 310 to form a common electrode for the plurality of active portions 310. The first electrode 60 may form a common electrode, and the second electrode 80 may form an individual electrode.

The piezoelectric layer 70 is configured, for example, using a piezoelectric material made of a perovskite structure composite oxide represented by the general formula ABO₃.

Further, an individual lead electrode 91 serving as a lead-out wiring is pulled out from the first electrode 60. Furthermore, a common lead electrode (not shown) serving as a lead-out wiring is pulled out from the second electrode 80. A wiring substrate 110 having flexibility is coupled to the end portions of these individual lead electrode 91 and common lead electrode opposite to the end portions coupled to the piezoelectric actuator 300. The wiring substrate 110 is mounted with a drive circuit 111 having a plurality of switching elements that select whether or not to supply a drive signal (COM) for driving each of the active portions 310 to each of the active portions 310. In other words, the wiring substrate 110 in the present embodiment is a chip-on-film (COF). The wiring substrate 110 may not be provided with the drive circuit 111. In other words, the wiring substrate 110 may be a flexible flat cable (FFC), a flexible printed circuit (FPC), and the like.

The protective substrate 30 having substantially the same size as the flow path forming substrate 10 is bonded to the surface of the flow path forming substrate 10 facing the −Z direction. The protective substrate 30 has a piezoelectric actuator accommodation portion 31 which is a space for protecting the piezoelectric actuator 300. The piezoelectric actuator accommodation portion 31 is independently provided for each row of the piezoelectric actuators 300 arranged side by side in the X-axis direction, and two piezoelectric actuator accommodation portions 31 are formed side by side in the Y-axis direction. A through hole 32 penetrating in the Z-axis direction is provided between two piezoelectric actuator accommodation portions 31 arranged side by side in the Y-axis direction, in the protective substrate 30. The end portions of the individual lead electrode 91 and a common lead electrode (not shown) pulled out from electrodes of the piezoelectric actuator 300 extend to be exposed within the through hole 32, and the individual lead electrode 91 and the common lead electrode are electrically coupled to the wiring substrate 110 within the through hole 32. Such a protective substrate 30 is made of, for example, a silicon substrate, similarly to the flow path forming substrate 10.

In addition, the case member 40 that defines a portion of the manifold 100 that communicates with the plurality of pressure chambers 12 is fixed onto the protective substrate 30. The case member 40 has substantially the same shape as the communication plate 15 described above in a plan view, and is bonded to the protective substrate 30 and also bonded to the communication plate 15 described above. Such a case member 40 has a recess portion 41 having a depth for accommodating the flow path forming substrate 10 and the protective substrate 30 on the protective substrate 30 side. The case member 40 is also provided with a third manifold portion 42 that communicates with the first manifold portion 17 of the communication plate 15. The first manifold portion 17 and the second manifold portion 18 provided in the communication plate 15 and the third manifold portion 42 provided in the case member 40 constitute the manifold 100 of the present embodiment. The manifolds 100 are provided continuously along the X-axis direction, which is the arrangement direction of the pressure chambers 12, and are provided for each row of the pressure chambers 12, that is, two manifolds in total. The case member 40 also has an introduction port 43 that communicates with the manifolds 100 and supplies ink to each manifold 100.

In addition, the case member 40 has a wiring coupling port 44 that communicates with the through hole 32 of the protective substrate 30 and through which the wiring substrate 110 is inserted, and the wiring substrate 110 is led out to the surface side of the liquid ejecting head 2 facing the −Z direction through the wiring coupling port 44. The case member 40 is made of, for example, a metal material or a resin material.

Further, a first fixing surface 15a of the communication plate 15 facing the +Z direction has a flow path opening 15b to which the first manifold portion 17 and the second manifold portion 18 which are a portion of the manifold 100 open. Note that the flow path opening 15b only indicates the end portion of the manifold 100 in the +Z direction, and has no depth in the Z-axis direction.

Further, the flexible member 120 is fixed to the first fixing surface 15a of the communication plate 15 with an adhesive 140. The flexible member 120 is made of a film-like member made of a thin film having flexibility. The flexible member 120 has a first surface 121 facing in the −Z direction and a second surface 122 facing in the +Z direction. The first surface 121 of the flexible member 120 is fixed to the first fixing surface 15a of the communication plate 15 facing the +Z direction with the adhesive 140.

A frame body 130 is fixed to the second surface 122 of the flexible member 120 with an adhesive 141. The linear expansion coefficient of the communication plate 15 is smaller than the linear expansion coefficient of the frame body 130. Moreover, the linear expansion coefficient of the flexible member 120 is smaller than the linear expansion coefficient of the frame body 130. The linear expansion coefficient of the flexible member 120 is preferably larger than the linear expansion coefficient of the communication plate 15. In other words, the relationship is: linear expansion coefficient of the communication plate 15<linear expansion coefficient of the flexible member 120<linear expansion coefficient of the frame body 130. The adhesive 141 may be applied to the entire second surface 122 of the flexible member 120.

At least one of the adhesive 140 and the adhesive 141 is a thermosetting adhesive. The thermosetting adhesive refers to a high-temperature curing adhesive that cures at, for example, 60° C. or higher. Moreover, a thermosetting adhesive is an adhesive that mainly contains a thermosetting resin. Examples of the thermosetting resin used as the thermosetting adhesive include an epoxy resin, a polyimide resin, a phenol resin, a urea resin, a melamine resin, an unsaturated polyester resin, and a diallyl phthalate resin. These may be used alone or in combination of two or more kinds in the form of a copolymer or blend. The thermosetting resin may contain a fiber base material such as glass fiber, and may contain a filler such as silica powder. In the present embodiment, a thermosetting adhesive made of an epoxy-based adhesive having particularly high liquid resistance is used as the adhesives 140 and 141. Incidentally, after curing, the thermosetting adhesive has the skeletal structure of the thermosetting resin used. For example, a thermosetting adhesive using an epoxy resin has an epoxy structural skeleton after curing.

The frame body 130 also has a first opening portion 131 and a second opening portion 132 that penetrate in the Z-axis direction. The first opening portion 131 exposes the plurality of nozzles 21. In the present embodiment, the first opening portion 131 has a size that exposes the nozzle plate 20. The second opening portion 132 is provided in a region overlapping the flow path opening 15b when viewed in the Z-axis direction. This second opening portion 132 divides the flexible member 120 into a flexible region 123, a fixed region 124, and an outer peripheral region 125.

The flexible region 123 is a region that overlaps the flow path opening 15b when viewed in the Z-axis direction and is not fixed to the frame body 130. In other words, the flexible region 123 is a region that is not fixed to the frame body 130 and the communication plate 15. In the present embodiment, since the second opening portion 132 is provided to overlap the flow path opening 15b when viewed in the Z-axis direction and has a larger opening area than the flow path opening 15b, the entire region that overlaps the flow path opening 15b of the flexible member 120 when viewed in the Z-axis direction constitutes the flexible region 123. A portion of the manifold 100 is sealed by the flexible region 123 of the flexible member 120, and the pressure fluctuations within the manifold 100 that occur when ink droplets are discharged and when ink is filled into the manifold 100 can be absorbed by the deformation of the flexible region 123. Therefore, the pressure fluctuations within the manifold 100 are absorbed by the flexible region 123, and it is possible to inhibit crosstalk caused by the pressure fluctuations in the pressure chamber 12 from which a liquid is ejected affecting the adjacent pressure chambers 12.

The fixed region 124 is a region that is fixed to both the communication plate 15 and the frame body 130. In other words, the fixed region 124 is a region where the communication plate 15, the flexible member 120, and the frame body 130 all overlap in the Z-axis direction. Such a fixed region 124 is provided over the outer periphery of the second opening portion 132, that is, to surround the flexible region 123.

The outer peripheral region 125 is a region that is adjacent to the flexible region 123 and surrounds the entire periphery of the flexible region 123 when viewed in the Z-axis direction, and between the flexible region 123 and the fixed region 124. Additionally, the outer peripheral region 125 has a first region 126 that is fixed to the communication plate 15 but is not fixed to the frame body 130. Since the outer peripheral region 125 in the present embodiment, which will be described in more detail later, is fixed to the frame body 130 but does not have a second region that is not fixed to the communication plate 15, the entire outer peripheral region 125 constitutes the first region 126. Therefore, 100% of the entire periphery of the outer peripheral region 125 is the first region 126. Here, “the entire periphery of the outer peripheral region 125” refers to the length of the inner periphery of the outer peripheral region 125. Therefore, the ratio of the first region 126 to the entire periphery of the outer peripheral region 125 is the presence ratio of the first region 126 to the length of the inner periphery of the outer peripheral region 125. In the present embodiment, since the first region 126 occupies 100% of the length of the inner periphery of the outer peripheral region 125, the flexible region 123 is defined by the edge portion of the flow path opening 15b. In other words, at any first position in the X-axis direction, which is the longitudinal direction of the flexible region 123, the communication plate 15, the flexible member 120, and the frame body 130 are cut into a plane perpendicular to the longitudinal direction, that is, in a cross section cut into the Y Z plane defined by the Y-axis and the Z-axis, that is, in the cross section shown in FIG. 5, the outer peripheral regions 125 located on both sides of the flexible region 123 are both first regions 126.

The first region 126 may be provided over 60% or more of the entire periphery of the outer peripheral region 125, preferably 80% or more, and more preferably 90% or more. By providing the first region 126 over 60% or more of the entire periphery of the outer peripheral region 125 in this manner, it is possible to reduce the occurrence of wrinkles in the flexible region 123, which will be described in detail later.

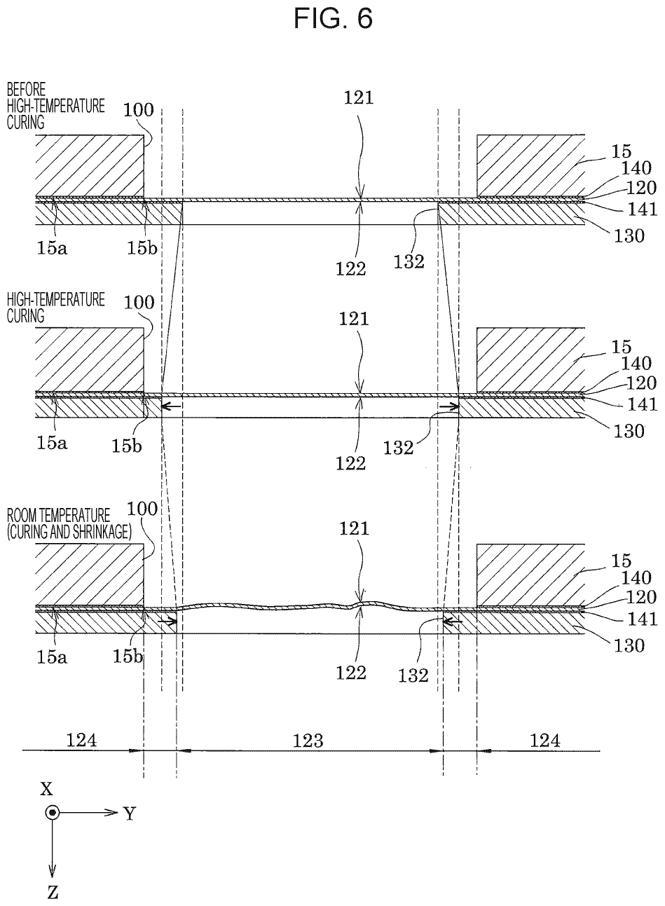

Here, a mechanism by which wrinkles occur in the flexible region 123 when the first region 126 of the related art is not provided will be described. FIG. 6 is a cross-sectional view of a main portion for describing a bonding process of the communication plate 15, the flexible member 120, and the frame body 130 in a configuration according to the related art.

As shown in FIG. 6, the first manifold of the frame body 130 has an opening area smaller than the flow path opening 15b. Therefore, the size of the flexible region 123 is defined by the opening edge portion of the second opening portion 132. In such a configuration, first, a stacked body in which the flexible member 120 and the frame body 130 are fixed with the adhesive 141 is brought into contact with the communication plate 15 through the uncured adhesive 140 (before high-temperature curing). Next, the adhesive 140 is cured at a high temperature of 60° C. or higher. At this time, since the linear expansion coefficient of the communication plate 15 is smaller than the linear expansion coefficient of the frame body 130, the edge portion of the second opening portion 132 of the frame body 130 expands outward, but the communication plate 15 expands less relative to the frame body 130. Furthermore, since the adhesive 141 was cured in advance, when the frame body 130 thermally expands, the adhesive 140 cures while the flexible region 123 of the flexible member 120 is in a state where it is strongly pulled. When the adhesive 140 is returned to room temperature after being cured at a high temperature, the portion of the frame body 130, particularly that facing the flow path opening 15b, tends to shrink back to its original state. Incidentally, the other portions of the frame body 130, in other words the portions that overlap the communication plate 15 when viewed in the Z-axis direction, are restrained by the communication plate 15 and do not move. In other words, when the frame body 130 returns to room temperature after thermal expansion, the portion of the frame body 130 facing the flow path opening 15b is not restrained by the communication plate 15, and therefore this portion shrinks, causing the flexible member 120 to shrink. The amount of shrinkage change of the flexible member 120 at this time becomes larger than the amount of shrinkage that occurs when the flexible member 120 itself returns to room temperature after thermal expansion, causing wrinkles to occur in the flexible region 123. The wrinkles in the flexible region 123 occur when no pressure fluctuation occurs within the manifold 100, and are also called wrinkles. When wrinkles occur in the flexible region 123 in this manner, the amount of change in displacement and cross-sectional area of the flexible region 123 in low pressure areas becomes smaller, thereby reducing the ability of the flexible region 123 to absorb pressure fluctuations within the manifold 100. This may result in a concern of so-called crosstalk occurring, in which pressure fluctuations in the pressure chamber 12 from which a liquid is ejected due to a reduction in the ability of the flexible region 123 affect adjacent pressure chambers 12. Furthermore, when wrinkles occur in the flexible region 123 and the flexible region 123 deforms in a convex shape toward the manifold 100, the volume of the manifold 100 decreases. In particular, in the present embodiment, the communication plate 15 is provided with the supply communication passages 19 that form a portion of the individual flow paths, and therefore the second manifold portion 18 is provided without penetrating the communication plate 15 in the Z-axis direction. Therefore, when wrinkles occur in the flexible region 123 to define the second manifold portion 18 and form a convex surface 18a facing the first surface 121, the flow path resistance in the second manifold portion 18 will increase, reducing the ability to supply ink from the manifold 100 to the pressure chamber 12, which may result in a reduction in ejection characteristics such as the weight and flight speed of the ink droplets, as well as problems such as the inability to discharge continuously at high speeds.

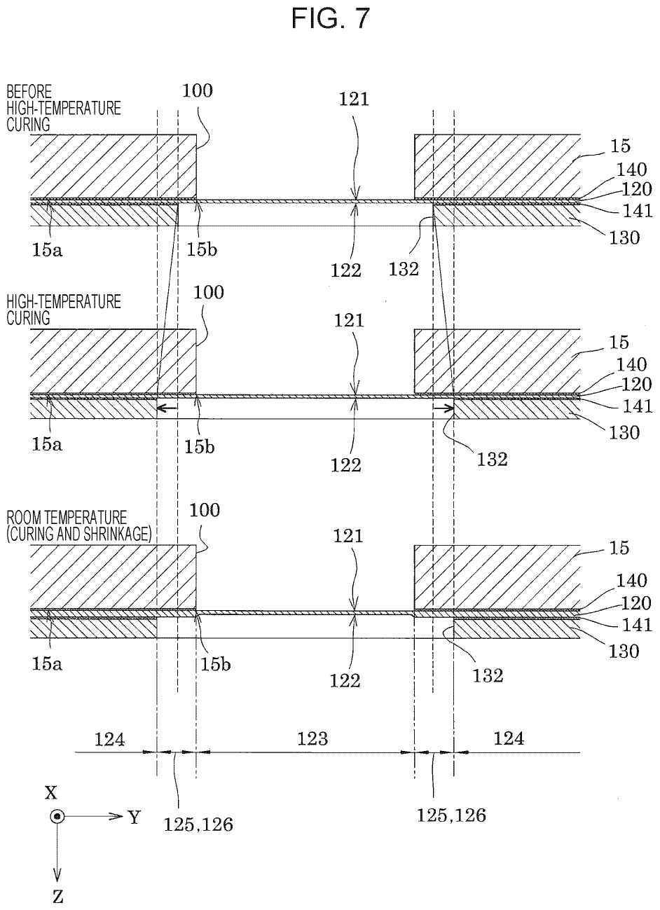

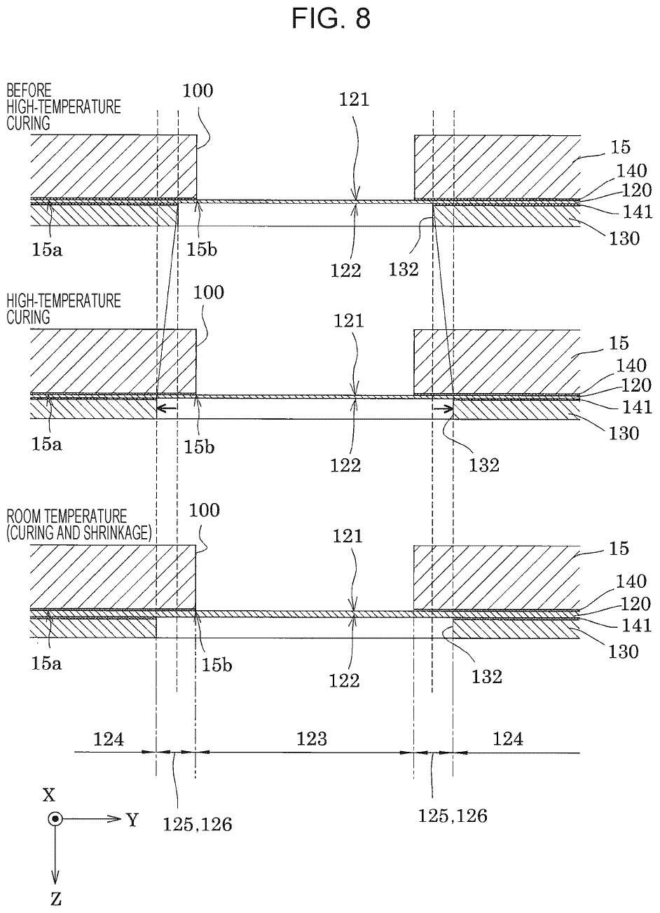

In contrast, the mechanism by which wrinkles are less likely to occur in the flexible region 123 when the first region 126 of the present embodiment is provided will be described. FIG. 7 is a cross-sectional view of a main portion for describing a bonding process of the communication plate 15, the flexible member 120, and the frame body 130 in the present embodiment. FIG. 8 is a diagram for describing a modification example of the bonding process of the communication plate 15, the flexible member 120, and the frame body 130.

As shown in FIG. 7, first, a stacked body in which the flexible member 120 and the frame body 130 are fixed with the adhesive 141 and the communication plate 15 are brought into contact with each other through the uncured adhesive 140 (before high-temperature curing). Next, the adhesive 140 is cured at a high temperature. At this time, since the linear expansion coefficient of the communication plate 15 is smaller than the linear expansion coefficient of the frame body 130, the edge portion of the second opening portion 132 of the frame body 130 expands outward, but the communication plate 15 expands less relative to the frame body 130. Furthermore, when the frame body 130 thermally expands, the adhesive 140 cures while the flexible region 123 of the flexible member 120, or more precisely, the region of the flexible member 120 that overlaps the second opening portion 132 when viewed in the Z-axis direction, is in a state where it is strongly pulled. After the adhesive 140 cures at a high temperature, the frame body 130 will attempt to shrink to its original state by returning the temperature to room temperature. However, since the frame body 130 is restrained by the communication plate 15 and there is no unrestrained portion as in the configuration according to the related art shown in FIG. 6, the frame body 130 is unlikely to shrink in such a way that the second opening portion 132 narrows. Furthermore, since the first region 126 and the fixed region 124 of the flexible member 120 are restrained by the communication plate 15, the flexible region 123 of the flexible member 120 attempts to shrink when the temperature is returned to room temperature from high-temperature curing. However, since the flexible region 123 was strongly pulled during the high-temperature curing, the flexible region 123 remains in a pulled state even when it shrinks. In the present embodiment, since the linear expansion coefficient of the flexible member 120 is larger than the linear expansion coefficient of the communication plate 15, when the temperature is returned to room temperature from high-temperature curing, the amount by which the flow path opening 15b of the communication plate 15 moves to narrow is smaller than the amount by which the flexible region 123 shrinks. Accordingly, the flexible region 123 is maintained in the pulled state. Therefore, it is possible to reduce the occurrence of wrinkles in the flexible region 123 when the adhesive 140 is returned to room temperature after being cured at a high temperature.

Also, as shown in FIG. 8, first, a stacked body in which the communication plate 15 and the flexible member 120 are bonded with the adhesive 140 and the frame body 130 are brought into contact with each other through uncured adhesive 141 (before high-temperature curing). Next, the adhesive 141 is cured at a high temperature. At this time, since the linear expansion coefficient of the frame body 130 is larger than the linear expansion coefficient of the communication plate 15 and the linear expansion coefficient of the flexible member 120, the adhesive 141 cures at a high temperature in a state where the edge portion of the second opening portion 132 expands outward. At this time, since the linear expansion coefficient of the flexible member 120 is larger than the linear expansion coefficient of the communication plate 15, the flexible region 123 bends slightly when cured at high temperatures. After the adhesive 140 cures at a high temperature, the frame body 130 will attempt to shrink to its original state by returning the temperature to room temperature. However, since the frame body 130 is restrained by the communication plate 15 and there is no unrestrained portion as in the configuration according to the related art shown in FIG. 6, the frame body 130 is unlikely to shrink in such a way that the second opening portion 132 narrows. Furthermore, the flexible region 123 of the flexible member 120 that wrinkles at high temperatures shrinks and returns to its original state, that is, to a state where wrinkles are reduced, when the temperature is returned to room temperature. Therefore, it is possible to reduce the occurrence of wrinkles in the flexible region 123 when the adhesive 141 is returned to room temperature after being cured at a high temperature.

In the above-mentioned FIGS. 7 and 8, either the adhesive 140 or the adhesive 141 is cured at a high temperature first, but the present disclosure is not particularly limited thereto, and the adhesive 140 and the adhesive 141 may be cured at a high temperature simultaneously. In other words, the communication plate 15, the flexible member 120, and the frame body 130 may be cured at a high temperature simultaneously with the adhesives 140 and 141. Even in this case, when the temperature is returned to room temperature after high-temperature curing, as in the cases shown in FIGS. 7 and 8, the frame body 130 will attempt to shrink to its original state by returning the temperature to room temperature. However, since the frame body 130 is restrained by the communication plate 15 and there is no portion that is not restrained by the communication plate 15 as in the configuration according to the related art shown in FIG. 6, the frame body 130 is unlikely to shrink in such a way that the second opening portion 132 narrows. Therefore, it is possible to reduce the occurrence of wrinkles in the flexible region 123 when the adhesives 140 and 141 are returned to room temperature after being cured at a high temperature.

Here, a combination of materials for the communication plate 15, the flexible member 120, and the frame body 130 with respect to their respective linear expansion coefficients will be described.

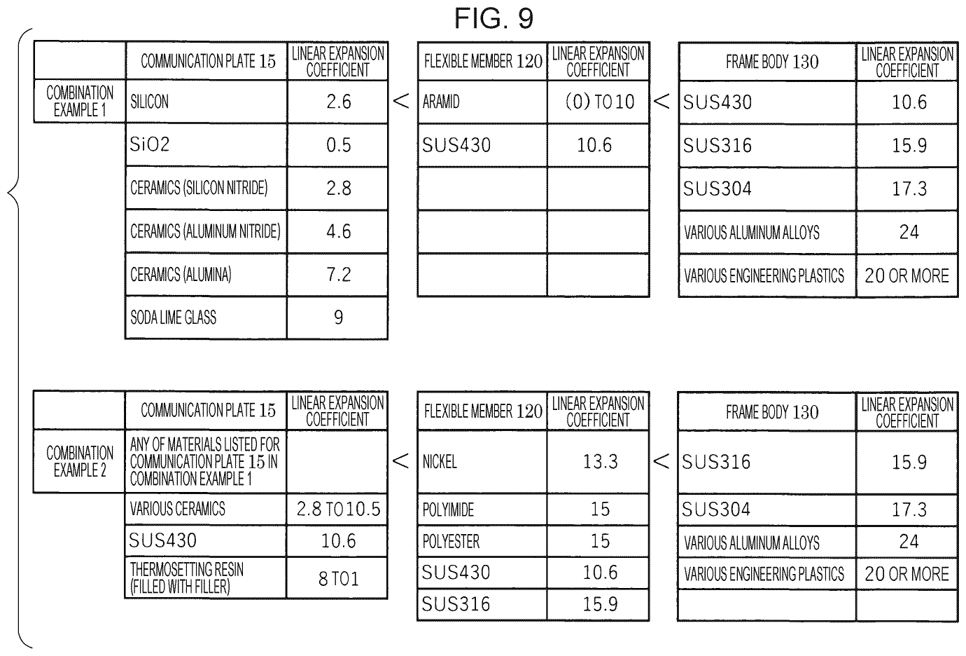

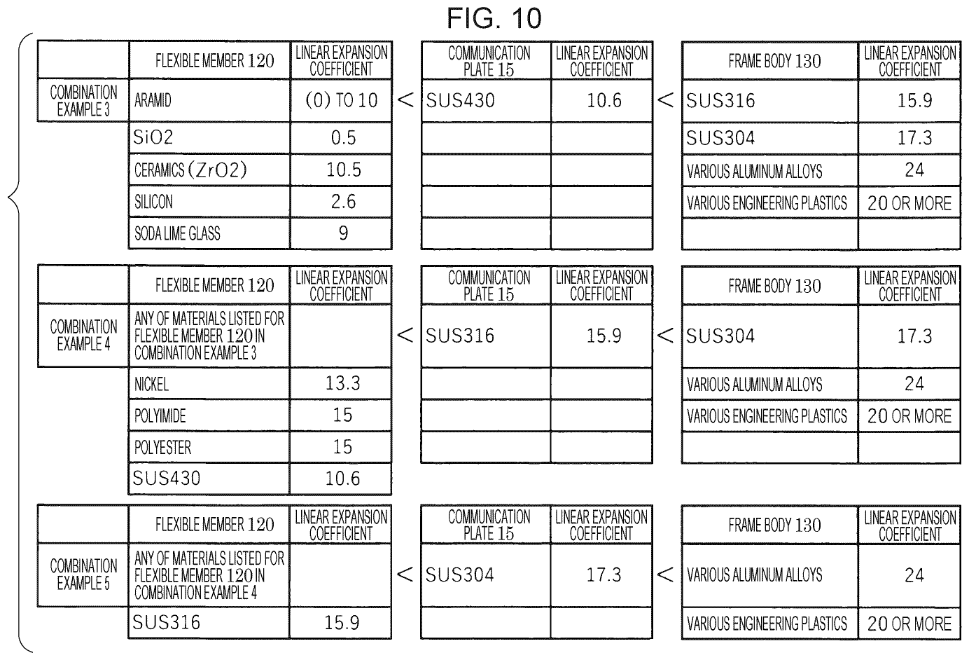

For example, as described above, the linear expansion coefficient of the flexible member 120 is smaller than the linear expansion coefficient of the frame body 130 and is larger than the linear expansion coefficient of the communication plate 15. That is, an example of a combination of materials that satisfies the relationship of linear expansion coefficient of the communication plate 15<linear expansion coefficient of the flexible member 120<linear expansion coefficient of the frame body 130 is as shown in the table of FIG. 9. The unit of the linear expansion coefficient shown in FIG. 9 is (×10⁻⁶/° C.). The same applies to FIGS. 10, 21, and 22 to be described later.

That is, as shown in Combination Example 1, when silicon is used for the communication plate 15, aramid can be selected for the flexible member 120 and stainless steel (SUS430) can be selected for the frame body 130.

Furthermore, as shown in Combination Example 1, when an inorganic material such as silicon or ceramics, which has a relatively low linear expansion coefficient, is used for the communication plate 15, an organic film or a metal can be selected for the flexible member 120, and various metals, engineering plastics, and the like can be selected for the frame body 130 according to the linear expansion coefficient. When stainless steel (SUS430) is selected for one of the flexible member 120 and the frame body 130, it is only necessary to select a material other than stainless steel (SUS430) for the other. Furthermore, when aramid is used for the flexible member 120, it is only necessary to select a type of aramid having a linear expansion coefficient larger than the linear expansion coefficient of the material selected for the communication plate 15.

Furthermore, as shown in Combination Example 2, when metal is used for the communication plate 15, an organic film or various metals can be selected for the flexible member 120, and various metals, engineering plastics, and the like can be selected for the frame body 130 from a wide range of materials according to the linear expansion coefficient. When stainless steel (SUS316) is selected for one of the flexible member 120 and the frame body 130, it is only necessary to select a material other than stainless steel (SUS316) for the other. Furthermore, the stainless steel (SUS430) is selected for one of the flexible member 120 and the communication plate 15, it is only necessary to select a material other than stainless steel (SUS316) for the other.

In addition, in the above-described embodiment, the linear expansion coefficient of the flexible member 120 is larger than the linear expansion coefficient of the communication plate 15, but the present disclosure is not particularly limited thereto, and the linear expansion coefficient of the flexible member 120 may be smaller than the linear expansion coefficient of the communication plate 15. In other words, the relationship of linear expansion coefficient of the flexible member 120<linear expansion coefficient of the communication plate 15<linear expansion coefficient of the frame body 130 may be satisfied. This is because if the linear expansion coefficient of the flexible member 120 is smaller than the linear expansion coefficient of the communication plate 15, there is a concern that some wrinkles will occur in the flexible region 123 due to shrinkage of the communication plate 15 when either the adhesive 140 or 141 is returned to room temperature after high-temperature curing during assembly; however, the occurrence of wrinkles can be reduced compared to the wrinkles in the flexible region 123 formed by shrinkage of the frame body 130. An example of the combination of materials for each member in such a case is shown in the table of FIG. 10.

In other words, as shown in Combination Example 3, when a ceramic, an organic film, or a metal having a relatively small linear expansion coefficient is used for the flexible member 120, various metals, engineering plastics, and the like can be selected for the communication plate 15 and the frame body 130 according to the linear expansion coefficient.

Furthermore, as shown in Combination Example 4, when the flexible member 120 is made of a metal or an organic film, various metals, engineering plastics, and the like can be selected for the communication plate 15 and the frame body 130 according to the linear expansion coefficient.

Furthermore, as shown in Combination Example 5, when the flexible member 120 is made of a metal, various metals, engineering plastics, and the like can be selected for the communication plate 15 and the frame body 130 according to the linear expansion coefficient.

Of course, the combinations of materials for the communication plate 15, the flexible member 120, and the frame body 130 are not limited to those shown in Combination Examples 1 to 5, as long as they satisfy the relationship in magnitude of the linear expansion coefficients described above.

The cover head 150 is fixed to the surface of the frame body 130 facing the +Z direction. The cover head 150 has an exposure opening portion 151 through which the nozzle 21 is exposed. In the present embodiment, the exposure opening portion 151 has a size that exposes the nozzle plate 20. In other words, the exposure opening portion 151 communicates with the first opening portion 131 of the frame body 130 and has substantially the same size as the first opening portion 131.

In the present embodiment, the cover head 150 is provided with a bent end portion to cover the side surface of the communication plate 15, that is, the surface that intersects with the nozzle surface 20a.

Such a cover head 150 is fixed to a surface of the frame body 130 facing the +Z direction to define a compliance space 152 between the cover head 150 and the flexible region 123 in which the flexible region 123 can deform. By providing this compliance space 152, pressure fluctuations within the manifold 100 can be alleviated by the flexible region 123.

In the present embodiment, the communication plate 15 is an example of a “first member”, the frame body 130 is an example of a “second member”, the Z-axis direction is an example of a “stacking direction”, the X-axis direction is an example of a “longitudinal direction”, and the Y-axis direction is an example of a “lateral direction”.

### Second Embodiment

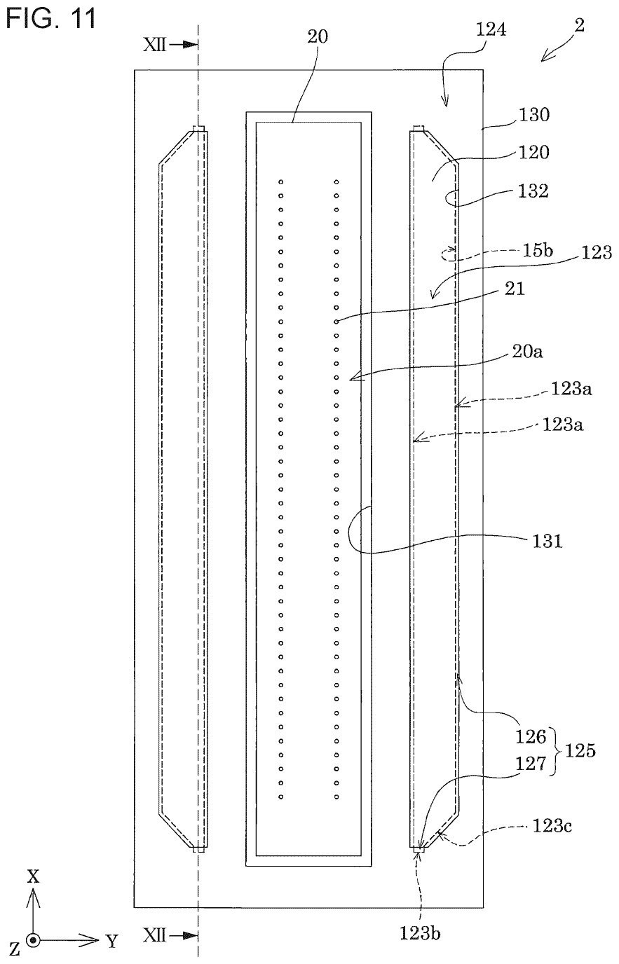

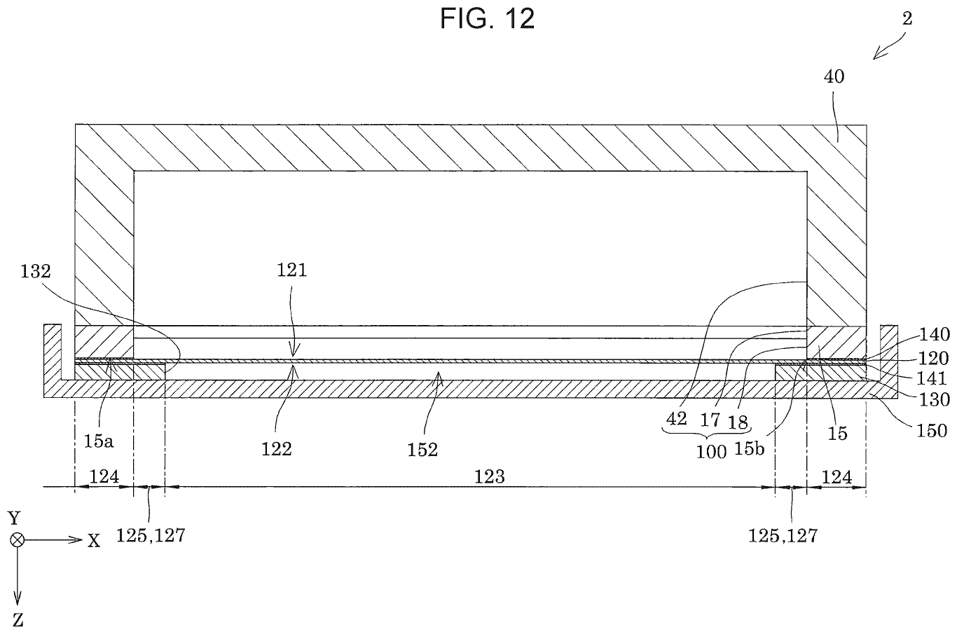

FIG. 11 is a plan view of a liquid ejecting head 2 according to a second embodiment of the present disclosure, when viewed in the −Z direction, with a cover head 150 removed from the liquid ejecting head 2. FIG. 12 is a cross-sectional view of a main portion of the liquid ejecting head 2 taken along line XII-XII of FIG. 11. In addition, since the cross section of the liquid ejecting head 2 taken along the Y Z plane is substantially the same as that shown in FIG. 4 and FIG. 5 of the above-described first embodiment, duplicated drawings will be omitted. Moreover, the same reference numerals are used for the same members as those in the above-described first embodiment, and the duplicated descriptions will be omitted.

As shown in the drawing, the liquid ejecting head 2 includes a communication plate 15, a flexible member 120, and a frame body 130. The flexible member 120 includes a flexible region 123, a fixed region 124, and an outer peripheral region 125.

The outer peripheral region 125 includes a first region 126 and a second region 127.

As described above, the first region 126 is a region of the outer peripheral region 125 that is fixed to the communication plate 15 but is not fixed to the frame body 130.

The first region 126 occupies 60% or more of the entire periphery of the outer peripheral region 125, preferably 80% or more, and more preferably 90% or more. Here, “the entire periphery of the outer peripheral region 125” refers to the length of the inner periphery of the outer peripheral region 125, as in the above-described first embodiment. Therefore, the ratio of the first region 126 to the entire periphery of the outer peripheral region 125 is the presence ratio of the first region 126 to the length of the inner periphery of the outer peripheral region 125. In addition, in the present embodiment, it is preferable that 80% or more of the entire portion of the outer peripheral region 125 along the longitudinal direction of the flexible region 123, that is, the X-axis direction, is the first region 126, and it is more preferable that it is 90% or more. The “portion along the longitudinal direction” refers to an axis along the longitudinal direction, which in the present embodiment forms an angle of ±80 degrees or less with respect to the X-axis direction.

The second region 127 is a region of the outer peripheral region 125 that is fixed to the frame body 130 but is not fixed to the communication plate 15. The second region 127 preferably occupies 1% or more and less than 10% of the entire periphery of the outer peripheral region 125. In the present embodiment, it is preferable that 80% or more of the entire portion of the outer peripheral region 125 along the lateral direction of the flexible region 123, that is, the Y-axis direction, is the second region 127, and it is more preferable that it is 90% or more. Of course, the second region 127 may be 100% of the portion along the lateral direction of the flexible region 123. The “portion along the lateral direction” refers to an axis along the lateral direction, which in the present embodiment forms an angle of less than ±10 degrees with respect to the Y-axis direction.

In the present embodiment, the flexible region 123 includes a first portion 123a along the X-axis direction, a second portion 123b along the Y-axis direction, and a third portion 123c that couples the first portion 123a and the second portion 123b and is inclined in both the X-axis direction and the Y-axis direction. Since an angle θ between the straight line extending in a direction along this third portion 123c and the X-axis is 80 degrees or less, the first portion 123a and the third portion 123c correspond to portions along the longitudinal direction, and the second portion 123b corresponds to a portion along the lateral direction. Therefore, the first region 126 is formed at the outer periphery of the first portion 123a and the third portion 123c, and the second region 127 is formed at the outer periphery of the second portion 123b.

When wrinkles occur in such a flexible region 123 along the longitudinal direction, the influence of the wrinkles is large. Therefore, by making 80% or more, and more preferably 90% or more, of the portion of the outer peripheral region 125 along the longitudinal direction of the flexible region 123 the first region 126, the occurrence of wrinkles along the longitudinal direction of the flexible region 123 can be reduced.

Furthermore, in the flexible region 123, the influence of wrinkles along the lateral direction is smaller than that of wrinkles along the longitudinal direction. Therefore, by making 80% or more, and more preferably 90% or more, of the portion of the outer peripheral region 125 along the lateral direction of the flexible region 123 the second region 127, the second region 127 can function as a portion that releases tensile stress applied to the flexible region 123, and a reduction in the ability of the flexible region 123 to absorb pressure fluctuations within the manifold 100 can be inhibited.

In the present embodiment, the communication plate 15 is an example of a “first member”, the frame body 130 is an example of a “second member”, the Z-axis direction is an example of a “stacking direction”, the X-axis direction is an example of a “longitudinal direction”, and the Y-axis direction is an example of a “lateral direction”.

### Third Embodiment

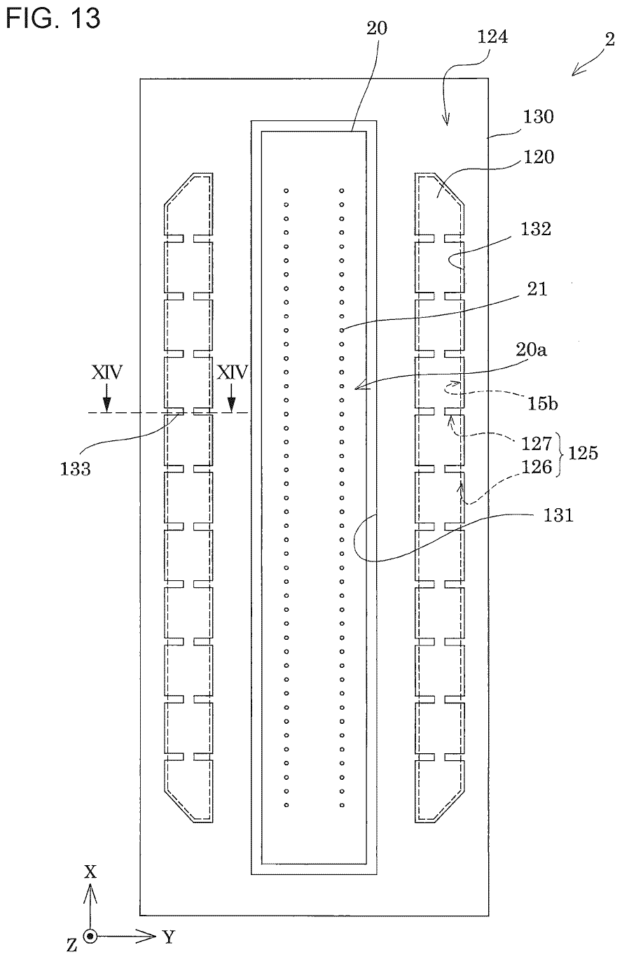

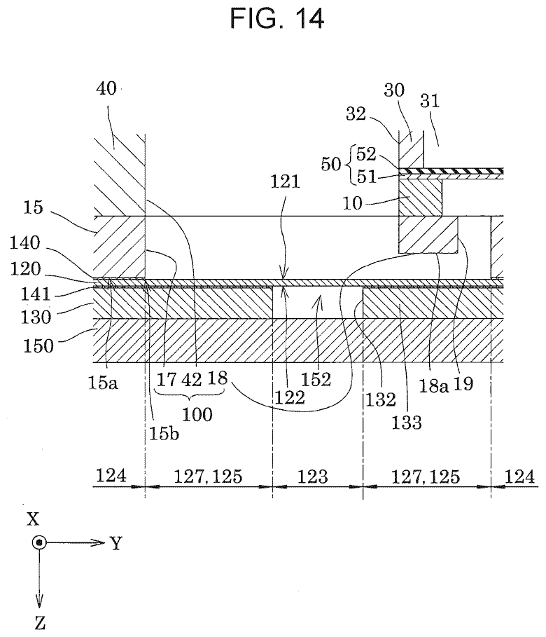

FIG. 13 is a plan view of a liquid ejecting head 2 according to a third embodiment of the present disclosure, when viewed in the −Z direction, with a cover head 150 removed from the liquid ejecting head 2. FIG. 14 is a cross-sectional view of a main portion of the liquid ejecting head 2 taken along line XIV-XIV of FIG. 13. In addition, the same reference numerals are used for the same members as those in the above-described embodiment, and a duplicated description will be omitted.

As shown in the drawing, the liquid ejecting head 2 includes a communication plate 15, a flexible member 120, a frame body 130, a cover head 150, and the like. The flexible member 120 includes a flexible region 123, a fixed region 124, and an outer peripheral region 125.

The frame body 130 has a first opening portion 131, a second opening portion 132, and a protrusion portion 133 that protrudes along the Y-axis direction from the opening edge portion of the second opening portion 132 to a region facing the inside of the flow path opening 15b, that is, a region facing the manifold 100 in the Z-axis direction. The protrusion portions 133 are provided to protrude from both sides of the opening edge portion of the second opening portion 132 in the Y-axis direction toward the center along the Y-axis direction. Furthermore, a plurality of protrusion portions 133 are provided at predetermined intervals in the X-axis direction. That is, the plurality of protrusion portions 133 are provided in a comb-teeth shape within the second opening portion 132 of the frame body 130. Furthermore, the tips of the two protrusion portions 133 facing each other in the Y-axis direction are disposed with a predetermined interval between them. Accordingly, a gap is formed between the two protrusion portions 133 facing each other in the Y-axis direction, and the compliance space 152 is provided in communication with the protrusion portions 133 without being partitioned.

Providing the protrusion portions 133 in this manner can restrict the flexible region 123 from moving toward the cover head 150, thereby inhibiting the flexible region 123 from sticking to the cover head 150.

The outer peripheral region 125 includes a first region 126 and a second region 127.

As described above, the first region 126 is a region of the outer peripheral region 125 that is fixed to the communication plate 15 but is not fixed to the frame body 130. The first region 126 occupies 60% or more of the entire periphery of the outer peripheral region 125, preferably 80% or more, and more preferably 90% or more.

The second region 127 is a region of the outer peripheral region 125 that is fixed to the frame body 130 but is not fixed to the communication plate 15. In the present embodiment, the second region 127 is a region that faces both the manifold 100 and the protrusion portion 133 in the Z-axis direction. Incidentally, the portion of the flexible member 120 facing the base end portion of the protrusion portion 133 is a fixed region 124 that is fixed to both the protrusion portion 133 and the communication plate 15. The second region 127 preferably occupies 1% or more of the entire periphery of the outer peripheral region 125, and more preferably less than 10%. This makes it possible to inhibit both the occurrence of wrinkles and the sticking of the flexible region 123 to the cover head 150 in a well-balanced manner.

Even when the protrusion portion 133 is provided in this manner, the same effects as those of the first embodiment described above can be achieved.

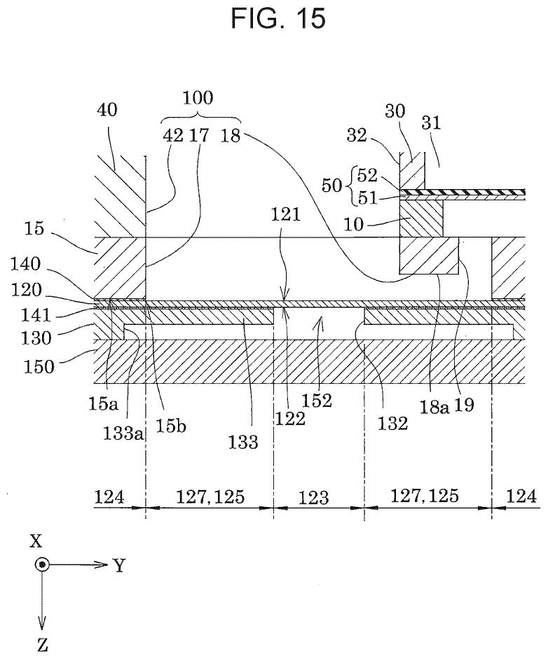

In the present embodiment, the protrusion portion 133 has the same thickness as the other regions, but the present disclosure is not particularly limited thereto. A modification example of the protrusion portion 133 is shown in FIG. 15. FIG. 15 is a cross-sectional view of a main portion of the liquid ejecting head 2, showing a modification example of the protrusion portion 133.

As shown in FIG. 15, the protrusion portion 133 has a recess portion 133a on the surface facing the +Z direction. The protrusion portion 133 has the recess portion 133a, so that the thickness in the Z-axis direction is thinner than other regions. By reducing the thickness of the protrusion portion 133 in this manner, a gap is formed between the protrusion portion 133 and the cover head 150, and the second region 127 of the flexible member 120 facing the protrusion portion 133 can be flexed and deformed. In other words, the second region 127 can function like the flexible region 123, and the protrusion portion 133 can inhibit the flexible region 123 from sticking to the cover head 150.

In the present embodiment, the communication plate 15 is an example of a “first member”, the frame body 130 is an example of a “second member”, the Z-axis direction is an example of a “stacking direction”, the X-axis direction is an example of a “longitudinal direction”, and the Y-axis direction is an example of a “lateral direction”.

### Fourth Embodiment

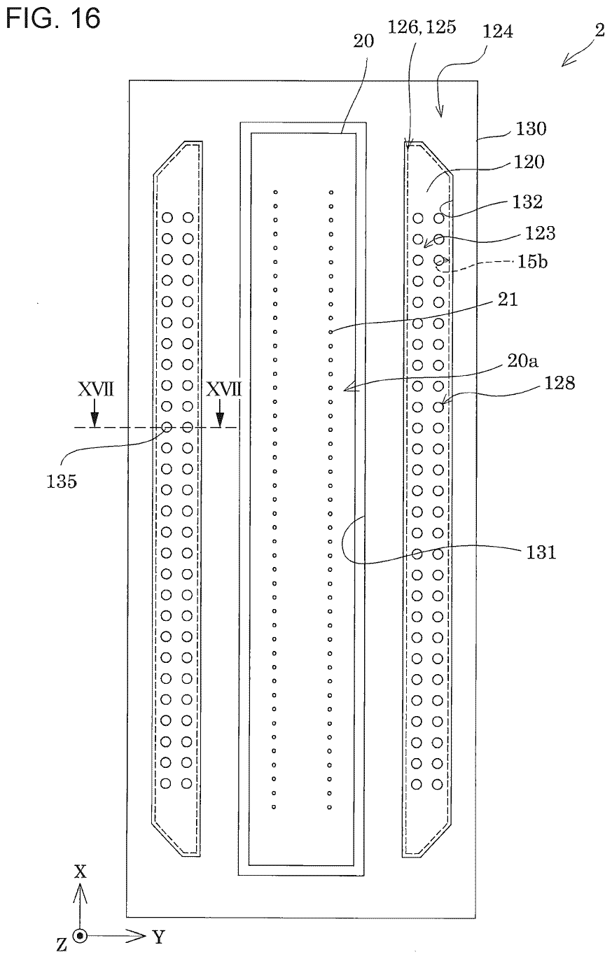

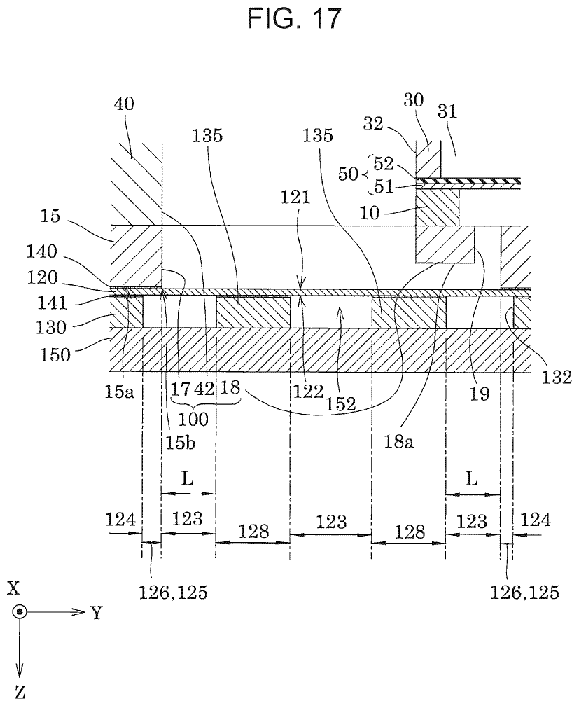

FIG. 16 is a plan view of a liquid ejecting head 2 according to a fourth embodiment of the present disclosure, when viewed in the −Z direction, with a cover head 150 removed from the liquid ejecting head 2. FIG. 17 is a cross-sectional view of a main portion of the liquid ejecting head 2 taken along line XVII-XVII of FIG. 16. In addition, the same reference numerals are used for the same members as those in the above-described embodiment, and a duplicated description will be omitted.

As shown in the drawing, the liquid ejecting head 2 includes a communication plate 15, a flexible member 120, a frame body 130, a cover head 150, and the like. The flexible member 120 includes a flexible region 123, a fixed region 124, an outer peripheral region 125, and a support region 128.

The frame body 130 has a plurality of island portions 135 at positions facing the flow path openings 15b in the Z-axis direction. The support region 128 is the region that is bonded to the island portion 135. The island portion 135 is preferably disposed at a position where a distance L from the opening edge portion of the flow path opening 15b is 40 times or less, more preferably 20 times or less, the thickness of the flexible member 120. For example, when the thickness of the flexible member 120 is 5 μm, the distance L from the opening edge portion of the flow path opening 15b of the island portion 135 is preferably 200 μm or less, and more preferably 100 μm or less.

Providing the island portion 135 in this manner makes it easier to press the first region 126 of the flexible member 120 against the communication plate 15 through the island portion 135, and bonding between the flexible member 120 and the communication plate 15 in the first region 126 with the adhesive 140 can be performed reliably. Furthermore, by providing the island portion 135, when the flexible region 123 of the flexible member 120 is flexed and deformed towards the cover head 150, excessive deformation can be inhibited, and therefore, sticking of the flexible region 123 to the cover head 150 can be inhibited. Furthermore, since the island portion 135 is disposed at a position a distance L away from the opening edge portion of the flow path opening 15b, even if the island portion 135 is provided, wrinkles are less likely to occur in the flexible region 123, as in the above-described first embodiment, and problems caused by wrinkles in the flexible region 123 can be inhibited.

In the present embodiment, the communication plate 15 is an example of a “first member”, the frame body 130 is an example of a “second member”, the Z-axis direction is an example of a “stacking direction”, the X-axis direction is an example of a “longitudinal direction”, and the Y-axis direction is an example of a “lateral direction”.

### Fifth Embodiment

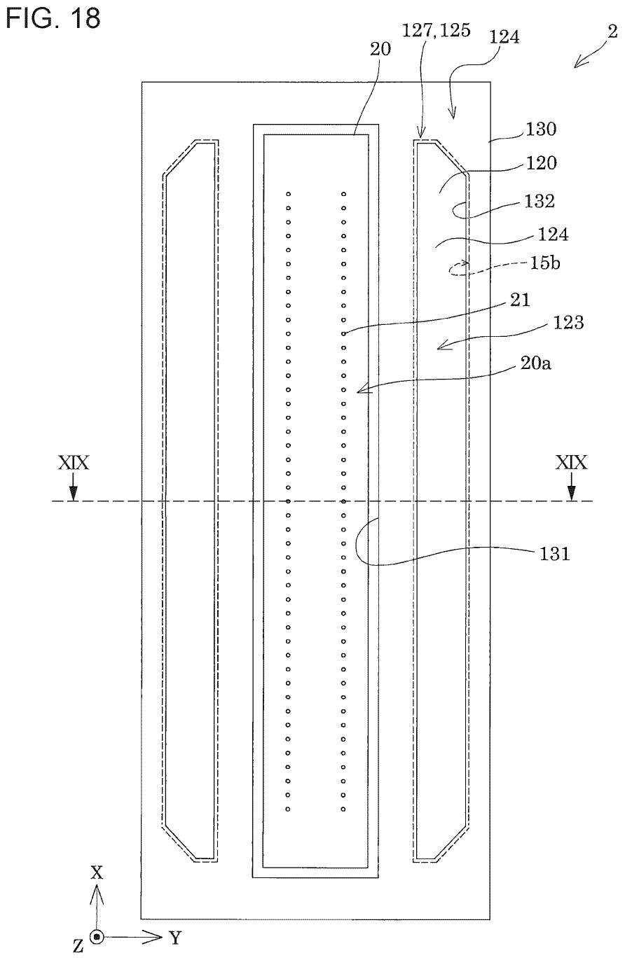

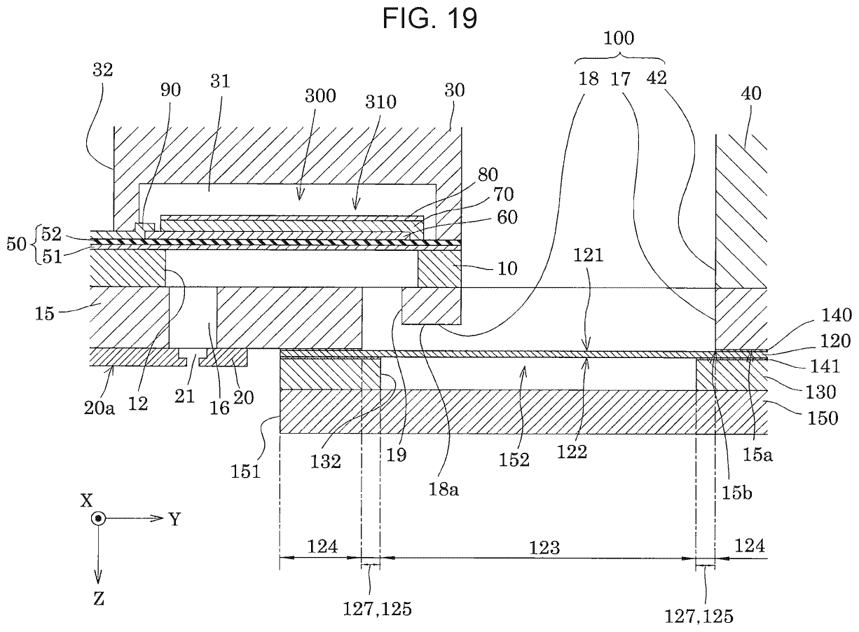

FIG. 18 is a plan view of a liquid ejecting head 2 according to a fifth embodiment of the present disclosure, when viewed in the −Z direction, with a cover head 150 removed from the liquid ejecting head 2. FIG. 19 is a cross-sectional view of a main portion of the liquid ejecting head 2 taken along line XIX-XIX of FIG. 18. In addition, the same reference numerals are used for the same members as those in the above-described embodiment, and a duplicated description will be omitted.

As shown in the drawing, the liquid ejecting head 2 of the present embodiment includes a communication plate 15, a flexible member 120, a frame body 130, a cover head 150, and the like. The flexible member 120 includes a flexible region 123, a fixed region 124, and an outer peripheral region 125.

The frame body 130 has a second opening portion 132 at a position facing the flow path openings 15b. This second opening portion 132 divides the flexible member 120 into a flexible region 123, a fixed region 124, and an outer peripheral region 125.

The flexible region 123 is a region that overlaps the flow path opening 15b when viewed in the Z-axis direction and is not fixed to the frame body 130. In other words, the flexible region 123 is a region that is not fixed to the frame body 130 and the communication plate 15. In the present embodiment, since the second opening portion 132 overlaps the flow path opening 15b when viewed in the Z-axis direction and has a smaller opening area than the flow path opening 15b, the region that overlaps the second opening portion 132 of the flexible member 120 when viewed in the Z-axis direction constitutes the flexible region 123.

The fixed region 124 is a region that is fixed to both the communication plate 15 and the frame body 130. In other words, the fixed region 124 is a region where the communication plate 15, the flexible member 120, and the frame body 130 all overlap in the Z-axis direction. Such a fixed region 124 is provided over the outer periphery of the second opening portion 132, that is, to surround the flexible region 123.

The outer peripheral region 125 is a region that is adjacent to the flexible region 123 when viewed in the Z-axis direction and surrounds the flexible region 123, and between the flexible region 123 and the fixed region 124. Additionally, the outer peripheral region 125 has a second region 127 that is fixed to the frame body 130 but is not fixed to the communication plate 15. Since the outer peripheral region 125 in the present embodiment is fixed to the frame body 130 but does not have a first region 126 (see FIG. 5) that is not fixed to the communication plate 15, the entire outer peripheral region 125 constitutes the second region 127. Therefore, 100% of the entire periphery of the outer peripheral region 125 is the second region 127. Here, “the entire periphery of the outer peripheral region 125” refers to the length of the inner periphery of the outer peripheral region 125. Therefore, the ratio of the second region 127 to the entire periphery of the outer peripheral region 125 is the presence ratio of the second region 127 to the length of the inner periphery of the outer peripheral region 125. In the present embodiment, since the second region 127 occupies 100% of the length of the inner periphery of the outer peripheral region 125, the flexible region 123 is defined by the edge portion of the second opening portion 132. In other words, at any first position in the X- axis direction, which is the longitudinal direction of the flexible region 123, the communication plate 15, the flexible member 120, and the frame body 130 are cut into a plane perpendicular to the longitudinal direction, that is, in a cross section cut into the Y Z plane defined by the Y-axis and the Z-axis, that is, in the cross section shown in FIG. 19, the outer peripheral regions 125 located on both sides of the flexible region 123 are both second regions 127.

The second region 127 may be provided over 60% or more of the entire periphery of the outer peripheral region 125, preferably 80% or more, and more preferably 90% or more. By providing the second region 127 over 60% or more of the entire periphery of the outer peripheral region 125 in this manner, it is possible to reduce wrinkles that occur in the flexible region 123, which will be described in detail later.

Here, the linear expansion coefficient of the frame body 130 in the present embodiment is smaller than the linear expansion coefficient of the communication plate 15. Moreover, the linear expansion coefficient of the flexible member 120 is smaller than the linear expansion coefficient of the communication plate 15. In addition, the linear expansion coefficient of the flexible member 120 is preferably larger than the linear expansion coefficient of the frame body 130. In other words, the relationship of linear expansion coefficient of the frame body 130<linear expansion coefficient of the flexible member 120<linear expansion coefficient of the communication plate 15 is satisfied.

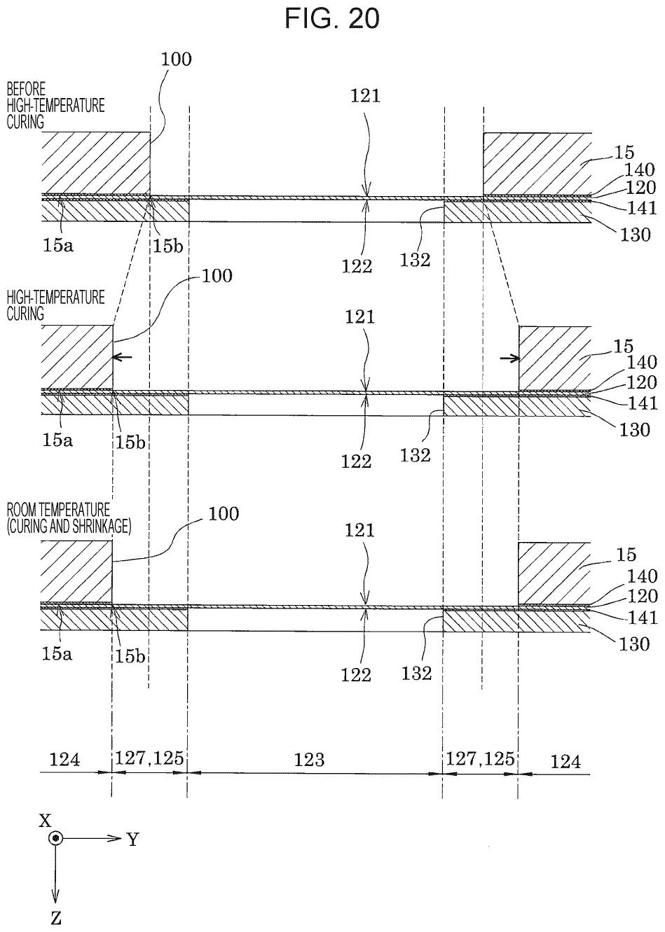

Here, the mechanism by which wrinkles are less likely to occur in the flexible region 123 when the second region 127 of the present embodiment is provided will be described. FIG. 20 is a cross-sectional view of a main portion for describing a bonding process of the communication plate 15, the flexible member 120, and the frame body 130 in the present embodiment.

As shown in FIG. 20, first, a stacked body in which the flexible member 120 and the frame body 130 are fixed with the adhesive 141 and the communication plate 15 are brought into contact with each other through the uncured adhesive 140 (before high-temperature curing). Next, the adhesive 140 is cured at a high temperature. At this time, since the linear expansion coefficient of the frame body 130 is smaller than the linear expansion coefficient of the communication plate 15, the adhesive 140 cures at a high temperature in a state where the edge portion of the flow path opening 15b of the communication plate 15 expands outward. At this time, the frame body 130 expands less than the communication plate 15. Furthermore, since the linear expansion coefficient of the flexible member 120 is larger than the linear expansion coefficient of the frame body 130, the flexible region 123 bends slightly when cured at high temperatures. After the adhesive 140 cures at a high temperature, the communication plate 15 will attempt to shrink to its original state by returning the temperature to room temperature. However, since the communication plate 15 is restrained by the frame body 130 and there is no region of the communication plate 15 that is not restrained by the frame body 130, the communication plate 15 is unlikely to shrink in such a way that the flow path opening 15b narrows. Furthermore, when the temperature is returned to room temperature after high-temperature curing, the flexible region 123 of the flexible member 120 shrinks and returns to its original state. Therefore, it is possible to reduce the occurrence of wrinkles in the flexible region 123 when the adhesive 140 is returned to room temperature after being cured at a high temperature.

Furthermore, even if the process involves first fixing the communication plate 15 and the flexible member 120 with the adhesive 140 to form a stacked body, and then bonding the stacked body and the frame body 130 by curing the adhesive 141 at a high temperature, the occurrence of wrinkles in the flexible region 123 can be reduced. Of course, even when the adhesives 140 and 141 are cured at the same time at high temperatures, the occurrence of wrinkles in the flexible region 123 can be reduced in a similar manner.

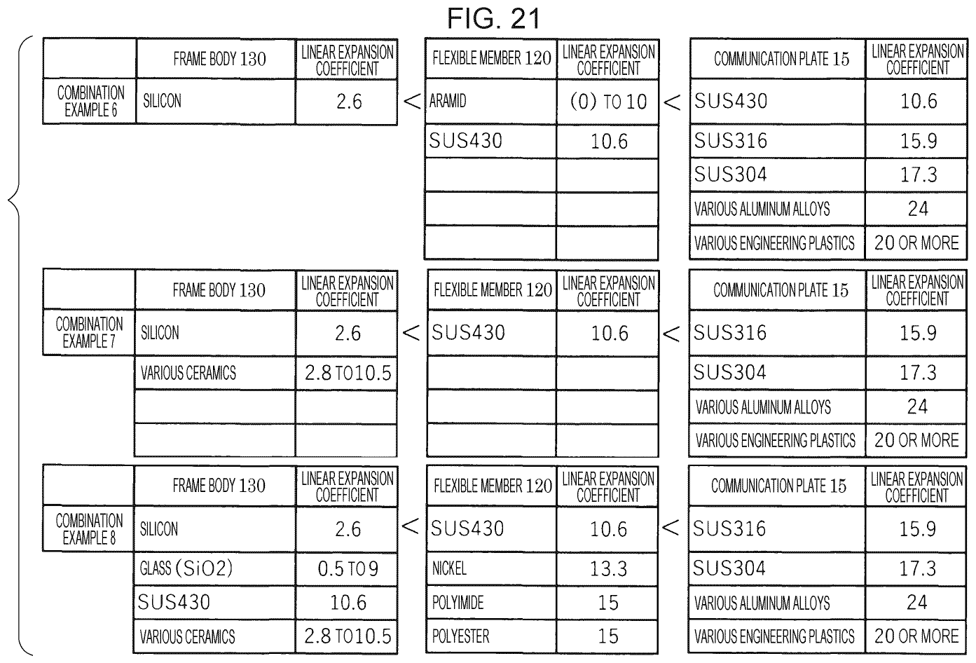

The linear expansion coefficient of such a frame body 130 is smaller than the linear expansion coefficient of the communication plate 15, the linear expansion coefficient of the flexible member 120 is smaller than the linear expansion coefficient of the communication plate 15, and the linear expansion coefficient of the flexible member 120 is larger than the linear expansion coefficient of the frame body 130. That is, an example of a combination of materials that satisfies the relationship of linear expansion coefficient of the frame body 130<linear expansion coefficient of the flexible member 120<linear expansion coefficient of the communication plate 15 is as shown in the table of FIG. 21.

In other words, as shown in Combination Example 6, when silicon is used for the frame body 130, an organic film or a metal can be selected for the flexible member 120, and various metals, engineering plastics, and the like can be selected for the communication plate 15 from a wide range of materials according to the linear expansion coefficient.

Furthermore, as shown in Combination Example 7, when silicon or various ceramics are used for the frame body 130, a metal can be selected for the flexible member 120, and various metals, engineering plastics, and the like can be selected for the communication plate 15 from a wide range of materials according to the linear expansion coefficient.

Furthermore, as shown in Combination Example 8, when silicon, glass, a metal, or various ceramics are used for the frame body 130, an organic film or a metal can be selected for the flexible member 120, and various metals, engineering plastics, and the like can be selected for the communication plate 15 from a wide range of materials according to the linear expansion coefficient.

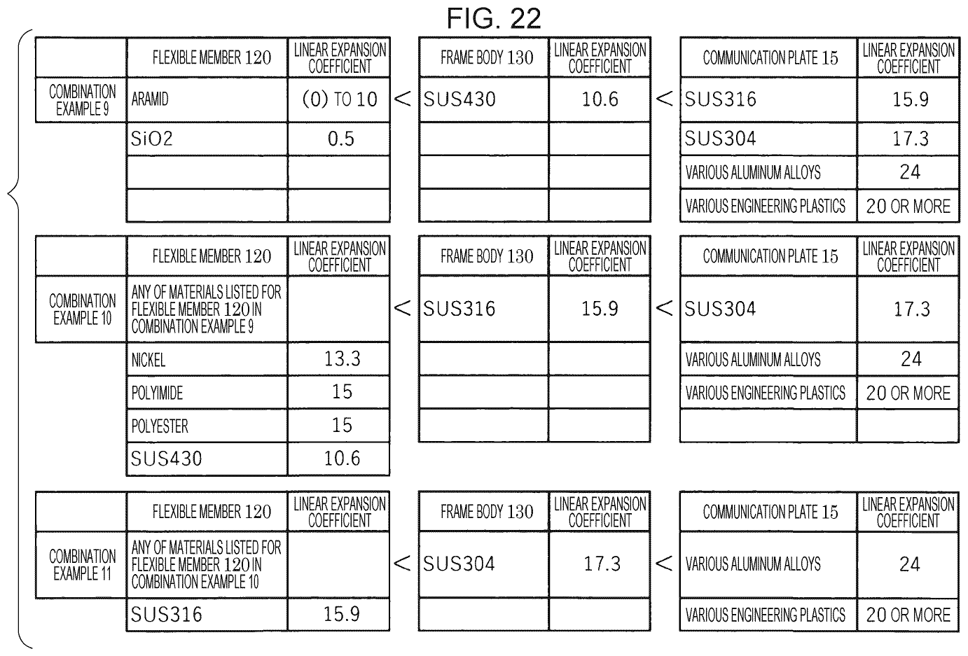

In addition, in the above-described example, the linear expansion coefficient of the flexible member 120 is larger than the linear expansion coefficient of the frame body 130, but the present disclosure is not particularly limited thereto, and the linear expansion coefficient of the flexible member 120 may be smaller than the linear expansion coefficient of the frame body 130. In other words, the relationship of linear expansion coefficient of the flexible member 120<linear expansion coefficient of the frame body 130<linear expansion coefficient of the communication plate 15 may be satisfied. This is because if the linear expansion coefficient of the flexible member 120 is smaller than the linear expansion coefficient of the frame body 130, there is a concern that some wrinkles will occur in the flexible region 123 due to shrinkage of the frame body 130 when either the adhesive 140 or 141 is returned to room temperature after high-temperature curing during assembly; however, the occurrence of wrinkles can be reduced compared to the wrinkles in the flexible region 123 formed by shrinkage of the communication plate 15. An example of the combination of materials for each member in such a case is shown in the table of FIG. 22.

In other words, as shown in Combination Example 9, when a ceramic or an organic film having a relatively small linear expansion coefficient is used for the flexible member 120, various metals can be selected for the frame body 130, and various metals, engineering plastics, and the like can be selected for the communication plate 15 according to the linear expansion coefficient.

Furthermore, as shown in Combination Example 10, when the flexible member 120 is made of a metal or an organic film, various metals can be selected for the frame body 130, and various metals, engineering plastics, and the like can be selected for the communication plate 15 according to the linear expansion coefficient.

Furthermore, as shown in Combination Example 11, when the flexible member 120 is made of a metal, various metals can be selected for the frame body 130, and various metals, engineering plastics, and the like can be selected for the communication plate 15 according to the linear expansion coefficient.

Of course, the combinations of materials for the communication plate 15, the flexible member 120, and the frame body 130 are not limited to those shown in Combination Examples 6 to 11, as long as they satisfy the relationship in magnitude of the linear expansion coefficients described above.

In addition, in the present embodiment, a configuration in which the outer peripheral region 125 does not have the first region 126 is exemplified, but the present disclosure is not particularly limited thereto, and a configuration in which the outer peripheral region 125 has the first region 126 may be employed. The second region 127 preferably occupies 80% or more of the entire portion of the outer peripheral region 125 along the X-axis direction, which is the longitudinal direction of the flexible region 123, and more preferably 90% or more. This can reduce the occurrence of wrinkles along the longitudinal direction of the flexible region 123. Of course, the second region 127 may be 100% of the flexible region 123 in the longitudinal direction.

Moreover, the first region 126 preferably occupies 1% or more and less than 10% of the entire periphery of the outer peripheral region 125. Moreover, the first region 126 preferably occupies 80% or more of the entire portion of the outer peripheral region 125 along the Y-axis direction, which is the lateral direction of the flexible region 123, and more preferably 90% or more.

In the present embodiment, the communication plate 15 is an example of a “first member”, the frame body 130 is an example of a “second member”, the manifold 100 is an example of a “common liquid chamber”, the Z-axis direction is an example of a “stacking direction”, the X-axis direction is an example of a “longitudinal direction”, and the Y-axis direction is an example of a “lateral direction”.

### Other Embodiments

Although the embodiments of the present disclosure are described above, the basic configuration of the present disclosure is not limited to the above embodiments.

For example, in each of the above-described embodiments, the manifold 100 of the liquid ejecting head 2 is exemplified as a “common liquid chamber”, but the present disclosure is not particularly limited thereto, and in a head unit including the above-described liquid ejecting head 2 and a flow path member including a holder that holds a plurality of liquid ejecting heads 2, a flow path provided in the flow path member and communicating with the manifold 100 may be an example of a “common liquid chamber”. In this case, the head unit corresponds to the “liquid ejecting head”.

In addition, in each of the above-described embodiments, the frame body 130 having the opening portion provided therein is exemplified as the “second member”, but the present disclosure is not particularly limited thereto. The “second member” may be, for example, a member in which the frame body 130 and the cover head 150 are integrated, that is, a plate-like member having a recess portion that opens on a surface facing the −Z direction. Furthermore, the compliance space 152 may be in communication with the atmosphere through an atmosphere communication passage (not shown).

In addition, in each of the above-described embodiments, at least one of the adhesive 140 and the adhesive 141 is a thermosetting adhesive, but the present disclosure is not particularly limited thereto, and the adhesive 140 and the adhesive 141 may be a room temperature curing adhesive, an ultraviolet-curing adhesive, or the like. Even when a thermosetting adhesive, particularly a high-temperature curing adhesive, is used in other locations within the liquid ejecting head 2, by providing a first region 126 in the outer peripheral region 125 as in the above-described first to fourth embodiments, and by providing a second region 127 in the outer peripheral region 125 as in the above-described fifth embodiment, it is possible to reduce the occurrence of wrinkles in the flexible region 123 when the thermosetting adhesive in other locations is heated and cured and then returned to room temperature.

In each of the above-described embodiments, the outer peripheral region 125 is composed of both the first region 126 and the second region 127, or at least one of the first region 126 and the second region 127, but the present disclosure is not limited thereto. A portion of the outer peripheral region 125 that surrounds and is adjacent to the flexible region 123 when viewed in the Z-axis direction may be a fixed region 124 that is interposed between both the frame body 130 and the communication plate 15. In other words, the outer peripheral region 125 may include a portion of the fixed region 124 in addition to at least one of the first region 126 and the second region 127.

In each of the above-described embodiments, a thin-film type piezoelectric actuator 300 was used as the drive element for generating a pressure change in the pressure chamber 12, but the present disclosure is not particularly limited thereto, and as the drive element, for example, a thick-film type piezoelectric actuator formed by a method such as adhering a green sheet, a longitudinal vibration type piezoelectric actuator in which piezoelectric material and electrode forming material are alternately stacked to expand and contract in the axial direction, or the like can be used. In addition, as the drive element, for example, an element in which a heating element is disposed in the pressure chamber 12 to eject the droplets from the nozzle 21 by bubbles generated due to the heat of the heating element, or a so-called electrostatic actuator that generates static electricity between a vibration plate and an electrode, deforms the vibration plate by the electrostatic force, and ejects the droplets from the nozzle 21 can be used.

Further, the present disclosure is intended to cover a wide range of liquid ejecting apparatuses equipped with liquid ejecting heads. Examples of the liquid ejecting head include recording heads such as various ink jet recording heads used in an image recording apparatus such as a printer, and coloring material ejecting heads used in the manufacture of color filters in liquid crystal displays and the like. Examples of the liquid ejecting head include an electrode material ejecting head used for forming an electrode in an organic EL display, a field emission display (FED), and the like, and a bioorganic substance ejecting head used for manufacturing a biochip. The present disclosure can also be applied to liquid ejecting apparatuses equipped with these liquid ejecting heads.

### Supplementary Notes

From the above-mentioned exemplary embodiments, the following configurations can be understood, for example.
According to Aspect 1 which is a preferred aspect, there is provided a liquid ejecting head including: a first member that defines a portion of a common liquid chamber communicating with a plurality of nozzles that eject a liquid; a second member; and a flexible member having a first surface fixed to a first fixing surface of the first member and a second surface opposite to the first surface and fixed to the second member, in which the first fixing surface has a flow path opening through which the common liquid chamber opens, the flexible member includes a flexible region that overlaps the flow path opening when viewed in a stacking direction of the first member and the flexible member and is not fixed to the second member, and an outer peripheral region that surrounds the flexible region when viewed in the stacking direction and is between the flexible region and a region that is fixed to both the first member and the second member, the outer peripheral region includes at least a first region that is fixed to the first member but not fixed to the second member, a linear expansion coefficient of the first member is smaller than a linear expansion coefficient of the second member, and 60% or more of an entire periphery of the outer peripheral region is the first region. In this way, when the linear expansion coefficient of the first member is smaller than the linear expansion coefficient of the second member, by providing the first region over 60% or more of the outer peripheral region, the occurrence of wrinkles in the flexible region can be reduced without any pressure fluctuations occurring in the common liquid chamber after assembly.
In Aspect 2 which is a specific example of Aspect 1, 80% or more of the entire periphery of the outer peripheral region is the first region. According to this, wrinkles are less likely to occur in the flexible region.
In Aspect 3 which is a specific example of Aspect 2, 90% or more of the entire periphery of the outer peripheral region is the first region. According to this, wrinkles are less likely to occur in the flexible region.
In Aspect 4 which is a specific example of Aspect 1, the outer peripheral region includes a second region that is fixed to the second member but not fixed to the first member. According to this, by providing the second region in the outer peripheral region, it is possible to reduce the flexible member from sticking to the member that faces the flexible region and defines the compliance space.
In Aspect 5 which is a specific example of Aspect 4, 1% or more of the entire periphery of the outer peripheral region is the second region. According to this, it is possible to achieve both a reduction in the occurrence of wrinkles in the flexible region by the first region and an inhibition of sticking to the member that defines the compliance space by the second region.
In Aspect 6 which is a specific example of Aspect 1, a linear expansion coefficient of the flexible member is smaller than the linear expansion coefficient of the second member.
In Aspect 7 which is a specific example of Aspect 6, the linear expansion coefficient of the flexible member is larger than the linear expansion coefficient of the first member. According to this, it is possible to reduce the occurrence of wrinkles in the flexible region.
In Aspect 8 which is a specific example of Aspect 1, at least one of fixing between the first surface and the first member and fixing between the second surface and the second member is performed by bonding with a thermosetting adhesive. According to this, since it is possible to reduce the occurrence of wrinkles in the flexible region due to the expansion of the first member and the second member when the thermosetting adhesive is heated and cured, and the shrinkage of the first member and the second member when returned to room temperature, a thermosetting adhesive with strong adhesive strength and liquid resistance can be used.
In Aspect 9 which is a specific example of Aspect 1, 80% or more of an entire portion of the outer peripheral region that extends along a longitudinal direction of the flexible region is the first region. According to this, when wrinkles occur along the longitudinal direction of the flexible region, the influence is large, and thus, by making 80% or more of the entire longitudinal direction of the flexible region the first region, wrinkles along the longitudinal direction can be effectively reduced.
In Aspect 10 which is a specific example of Aspect 9, 80% or more of an entire portion of the outer peripheral region along a lateral direction of the flexible region includes a second region that is fixed to the second member but not fixed to the first member. According to this, by forming the first region around the portion along the longitudinal direction of the flexible region, it is possible to improve ease of assembly. Furthermore, by forming the second region around the portion along the lateral direction where the effects of wrinkles are less likely to occur, it is possible to release internal stress in the flexible member, and to inhibit a reduction in the amount by which the flexible region deforms in response to pressure fluctuations in the common liquid chamber.
In Aspect 11 which is a specific example of Aspect 1, in a cross section obtained by cutting the first member, the flexible member, and the second member at a first position in a longitudinal direction of the flexible region with a plane perpendicular to the longitudinal direction, the outer peripheral regions located on both sides of the flexible region are both the first region.
In Aspect 12 which is a specific example of Aspect 1, the first member further defines a portion of a plurality of individual flow paths communicating with each of the plurality of nozzles, and the portion of the common liquid chamber defined by the first member is coupled to the plurality of individual flow paths. According to this, the first member in which the individual flow paths are formed has a narrower height of the common liquid chamber, thereby reducing wrinkles in the flexible member and inhibiting a reduction in the volume of the common liquid chamber due to wrinkles in the flexible member and an increase in flow path resistance toward the individual flow paths of the common liquid chamber.
According to Aspect 13 which is a preferred aspect, there is provided a liquid ejecting head including: a first member that defines a portion of a common liquid chamber communicating with a plurality of nozzles that eject a liquid; a second member; and a flexible member having a first surface fixed to a first fixing surface of the first member and a second surface opposite to the first surface and fixed to the second member, in which the first fixing surface has a flow path opening through which the common liquid chamber opens, the flexible member includes a flexible region that overlaps the flow path opening when viewed in a stacking direction of the first member and the flexible member and is not fixed to the second member, and an outer peripheral region that surrounds the flexible region when viewed in the stacking direction and is between the flexible region and a region that is fixed to both the first member and the second member, the outer peripheral region includes at least a second region that is fixed to the second member but not fixed to the first member, a linear expansion coefficient of the second member is smaller than a linear expansion coefficient of the first member, and 60% or more of an entire periphery of the outer peripheral region is the second region. In this way, when the linear expansion coefficient of the second member is smaller than the linear expansion coefficient of the first member, by providing the second region over 60% or more of the outer peripheral region, the occurrence of wrinkles in the flexible region can be reduced without any pressure fluctuations occurring in the common liquid chamber after assembly.
In Aspect 14 which is a specific example of Aspect 13, a linear expansion coefficient of the flexible member is smaller than the linear expansion coefficient of the first member.
In Aspect 15 which is a specific example of Aspect 14, the linear expansion coefficient of the flexible member is larger than the linear expansion coefficient of the second member. According to this, it is possible to reduce the occurrence of wrinkles in the flexible region.
According to Aspect 16 which is a preferred aspect, there is provided a liquid ejecting apparatus including: the liquid ejecting head according to the above aspect; and a liquid storage portion that stores a liquid to be supplied to the liquid ejecting head. According to this, it is possible to realize a liquid ejecting apparatus that reduces the occurrence of wrinkles in the flexible member and inhibits problems such as discharge failures.

What is claimed is:

1. A liquid ejecting head comprising:
a first member that defines a portion of a common liquid chamber communicating with nozzles configured to eject a liquid;
a second member; and
a flexible member having a first surface fixed to a first fixing surface of the first member and a second surface that is opposite from the first surface and that is fixed to the second member, wherein
the first fixing surface has a flow path opening through which the common liquid chamber opens,
the flexible member includes
a flexible region that overlaps the flow path opening when viewed in a stacking direction of the first member and the flexible member and is not fixed to the second member, and
an outer peripheral region that surrounds the flexible region when viewed in the stacking direction and is between the flexible region and a region that is fixed to both the first member and the second member,
the outer peripheral region includes at least a first region that is fixed to the first member but not fixed to the second member,
a linear expansion coefficient of the first member is smaller than a linear expansion coefficient of the second member, and
60% or more of an entire periphery of the outer peripheral region is the first region.

2. The liquid ejecting head according to claim 1, wherein
80% or more of the entire periphery of the outer peripheral region is the first region.

3. The liquid ejecting head according to claim 2, wherein
90% or more of the entire periphery of the outer peripheral region is the first region.

4. The liquid ejecting head according to claim 1, wherein
the outer peripheral region includes a second region that is fixed to the second member but not fixed to the first member.

5. The liquid ejecting head according to claim 4, wherein
1% or more of the entire periphery of the outer peripheral region is the second region.

6. The liquid ejecting head according to claim 1, wherein
a linear expansion coefficient of the flexible member is smaller than the linear expansion coefficient of the second member.

7. The liquid ejecting head according to claim 6, wherein
the linear expansion coefficient of the flexible member is larger than the linear expansion coefficient of the first member.

8. The liquid ejecting head according to claim 1, wherein
at least one of fixing between the first surface and the first member and fixing between the second surface and the second member is performed by bonding with a thermosetting adhesive.

9. The liquid ejecting head according to claim 1, wherein
80% or more of an entire portion of the outer peripheral region that extends along a longitudinal direction of the flexible region is the first region.

10. The liquid ejecting head according to claim 9, wherein
80% or more of an entire portion of the outer peripheral region along a lateral direction of the flexible region includes a second region that is fixed to the second member but not fixed to the first member.

11. The liquid ejecting head according to claim 1, wherein
in a cross section obtained by cutting the first member, the flexible member, and the second member at a first position in a longitudinal direction of the flexible region with a plane perpendicular to the longitudinal direction, portions of the outer peripheral region located on both sides of the flexible region are both the first region.

12. The liquid ejecting head according to claim 1, wherein
the first member further defines a portion of individual flow paths communicating with each of the nozzles, and
the portion of the common liquid chamber defined by the first member is coupled to the individual flow paths.

13. A liquid ejecting head comprising:
a first member that defines a portion of a common liquid chamber communicating with nozzles configured to eject a liquid;
a second member; and
a flexible member having a first surface fixed to a first fixing surface of the first member and a second surface that is opposite from the first surface and that is fixed to the second member, wherein
the first fixing surface has a flow path opening through which the common liquid chamber opens,
the flexible member includes
a flexible region that overlaps the flow path opening when viewed in a stacking direction of the first member and the flexible member and is not fixed to the second member, and
an outer peripheral region that surrounds the flexible region when viewed in the stacking direction and is between the flexible region and a region that is fixed to both the first member and the second member,
the outer peripheral region includes at least a second region that is fixed to the second member but not fixed to the first member,
a linear expansion coefficient of the second member is smaller than a linear expansion coefficient of the first member, and
60% or more of an entire periphery of the outer peripheral region is the second region.

14. The liquid ejecting head according to claim 13, wherein
a linear expansion coefficient of the flexible member is smaller than the linear expansion coefficient of the first member.

15. The liquid ejecting head according to claim 14, wherein
the linear expansion coefficient of the flexible member is larger than the linear expansion coefficient of the second member.

16. A liquid ejecting apparatus comprising:
the liquid ejecting head according to claim 1; and
a liquid storage portion that stores a liquid to be supplied to the liquid ejecting head.
